(19) United States
(12) Patent Application Publication
(10) Pub. No.: US 2026/0280892 A1
(43) Pub. Date: Sep. 17, 2026

(54) SYSTEM

(71) Applicant: SoftBank Group Corp., Tokyo (JP)

(72) Inventor: Jumpei SATO, Tokyo (JP)

(73) Assignee: SoftBank Group Corp., Tokyo (JP)

(21) Appl. No.: 19/547,674

(22) Filed: Feb. 24, 2026

Related U.S. Application Data
(60) Provisional application No. 63/769,971, filed on Mar. 11, 2025.

(51) Int. Cl. H04L 9/32; G06N 3/0464; H04L 9/00

(52) U.S. Cl. CPC H04L 9/3236; G06N 3/0464; H04L 9/3247; H04L 9/50

(57) ABSTRACT

A system includes a processor that is configured to: receive, via an input unit, a generated content created by a generative artificial intelligence and uploaded for copyright management and similarity checking; generate, via a hash generation unit, a hash value of the uploaded generated content; record, via a recording unit, the generated hash value on a blockchain; check, via a similarity checking unit, whether the generated content is similar to an existing copyrighted work; issue, via a warning unit, a warning to a user based on a result of the similarity checking; and provide, via an API providing unit, an application programming interface for integration with a generative artificial intelligence platform.

### CROSS-REFERENCE TO RELATED APPLICATION

This application is based on and claims priority under 35 USC 119 (e) from U.S. Provisional Application No. 63/769,971 filed on Mar. 11, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional content management systems and copyright management tools are not designed to address the specific characteristics and risks associated with content generated by generative artificial intelligence. In particular, when users create text, images, or videos using generative AI, it is difficult to reliably prove the existence and authorship of the generated content at a particular point in time, and it is also difficult to automatically evaluate whether the generated content is similar to existing copyrighted works. Existing systems generally lack a unified mechanism that (i) receives AI-generated content, (ii) generates a robust digital fingerprint as a hash, (iii) records that hash in an immutable or tamper-resistant manner, and (iv) automatically checks similarity against existing works and warns the user of potential copyright infringement risks. As a result, users and generative AI platforms face legal uncertainty, increased risk of unintentional copyright infringement, and operational burdens in separately managing proof of existence and similarity checking across different types of content such as text, images, and video.

### SUMMARY

In order to solve the above-described problems, a system is provided that comprises a processor configured to perform, in an integrated manner, copyright management and similarity checking for content generated by a generative artificial intelligence. In one aspect, the processor is configured to receive, via an input unit, generated content uploaded for copyright management and similarity checking, to generate, via a hash generation unit, a hash value of the uploaded content by using a hash function that uniquely identifies a digital fingerprint of the content, and to record, via a recording unit, the generated hash value on a blockchain using distributed ledger technology in a tamper-resistant manner so as to provide proof of existence of the content. In another aspect, the processor is further configured to check, via a similarity checking unit, whether the generated content is similar to existing copyrighted works, wherein, for text content, the processor uses natural language processing to tokenize the text, convert the tokens into vectors, and calculate a similarity degree, for image content, the processor uses image recognition technology to extract feature values and evaluate a similarity degree, and for video content, the processor divides the video into frames, processes each frame as an image, and evaluates similarity based on the processed frames. The processor is also configured to issue, via a warning unit, a warning to a user based on a result of the similarity checking, and to provide, via an API providing unit, an application programming interface that allows a generative artificial intelligence platform to seamlessly invoke the hash generation, blockchain recording, and similarity checking functions. By these means, the system enables reliable proof of existence for AI-generated content and automatic, content-type-specific similarity evaluation, thereby reducing the risk of copyright infringement and operational burden for users and platforms.

The term “system” refers to a combination of hardware and software components, including at least one processor and associated functional units, that collectively perform the operations recited in the claims.

The term “processor” refers to any hardware device or combination of hardware devices capable of executing instructions, including but not limited to a central processing unit (CPU), a graphics processing unit (GPU), a digital signal processor (DSP), a microcontroller, or a plurality of such devices operating together.

The term “input unit” refers to a hardware and software component configured to receive generated content and related data from an external device or network, including interfaces such as network interfaces, file upload interfaces, application programming interfaces, or user interface components.

The term “generated content” refers to any data or work product, including text, images, and video, that is created, at least in part, by a generative artificial intelligence system in response to input or instructions.

The term “generative artificial intelligence” refers to an artificial intelligence system or model that generates new data, such as text, images, audio, or video, based on training data and input prompts, rather than merely classifying or retrieving existing data.

The term “copyright management” refers to processes and functions for managing rights related to generated content, including at least proof of existence, linkage to a creator or user, and support for assessing potential infringement risk.

The term “similarity checking” refers to analyzing generated content to determine a degree of similarity between the generated content and one or more existing works, based on text analysis, image analysis, video analysis, or other content comparison techniques. The term “hash generation unit” refers to a functional component implemented by the processor, configured to compute a hash value from the data of generated content using a hash function so as to produce a digital fingerprint of the content.

The term “hash value” refers to a fixed-length digital value generated by applying a hash function to the data of the generated content, which acts as a digital fingerprint that uniquely identifies the content with high probability.

The term “hash function” refers to a deterministic algorithm that maps input data of arbitrary size to a fixed-size hash value, such that changes to the input data result in different hash values with high probability.

The term “digital fingerprint” refers to a representation of content derived from a hash function or similar algorithm, which is used to uniquely identify the content and detect modifications to the content.

The term “recording unit” refers to a functional component implemented by the processor, configured to submit and record the generated hash value onto a blockchain or distributed ledger so that the record is tamper-resistant.

The term “blockchain” refers to a distributed ledger technology that stores data in blocks that are cryptographically linked, where each block typically contains a hash of the previous block, making modification of recorded data difficult without detection.

The term “distributed ledger technology” refers to a system for recording and sharing data across multiple nodes in a network, in which records are synchronized, cryptographically secured, and resistant to tampering or unilateral modification.

The term “proof of existence” refers to evidence indicating that specific content, identified by a hash value or digital fingerprint, existed at or before a particular time, as demonstrated by a record stored on a blockchain or distributed ledger.

The term “similarity checking unit” refers to a functional component implemented by the processor, configured to perform analysis on generated content and compare it with existing works to determine a similarity degree.

The term “similarity degree” refers to a numerical or quantitative value that represents the level of similarity between generated content and an existing work, typically within a normalized range such as 0.0 to 1.0.

The term “warning unit” refers to a functional component implemented by the processor, configured to generate and provide a warning message or notification to a user based on the result of the similarity checking.

The term “API providing unit” refers to a functional component implemented by the processor, configured to provide an application programming interface that allows external systems, including generative artificial intelligence platforms, to access functions of the system.

The term “application programming interface” refers to a set of defined methods, endpoints, data formats, and protocols that enable one software system to programmatically request services or exchange data with another software system.

The term “generative artificial intelligence platform” refers to a software platform or service that provides generative artificial intelligence capabilities, such as generating text, images, or video from prompts, and that can integrate with the claimed system via the application programming interface.

The term “text content” refers to generated content represented primarily as a sequence of characters, words, or sentences, including but not limited to stories, articles, or captions. The term “image content” refers to generated content represented primarily as a two-dimensional visual representation, including but not limited to digital photographs, illustrations, or graphics.

The term “video content” refers to generated content represented as a sequence of images or frames displayed over time, optionally including audio, constituting a moving picture or animation.

The term “tokenize” refers to dividing text into smaller units, such as words, subwords, or symbols, that can be processed by natural language processing algorithms.

The term “vector” refers to a numerical representation of content or features, such as a list or array of numeric values, used as input to similarity calculations or machine learning models. The term “natural language processing” refers to computational techniques and algorithms for analyzing, understanding, and processing human language text.

The term “image recognition technology” refers to algorithms and models configured to analyze image data and extract features or patterns for classification, comparison, or similarity measurement.

The term “feature values” refers to numerical or symbolic representations extracted from content, such as text, images, or video frames, that capture distinguishable characteristics used for comparison or classification.

The term “frame” refers to a single still image from a sequence of images that compose a video, which can be analyzed individually for similarity checking.

The term “user” refers to any human or entity that utilizes the generative artificial intelligence and the claimed system to generate, upload, manage, or evaluate content.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

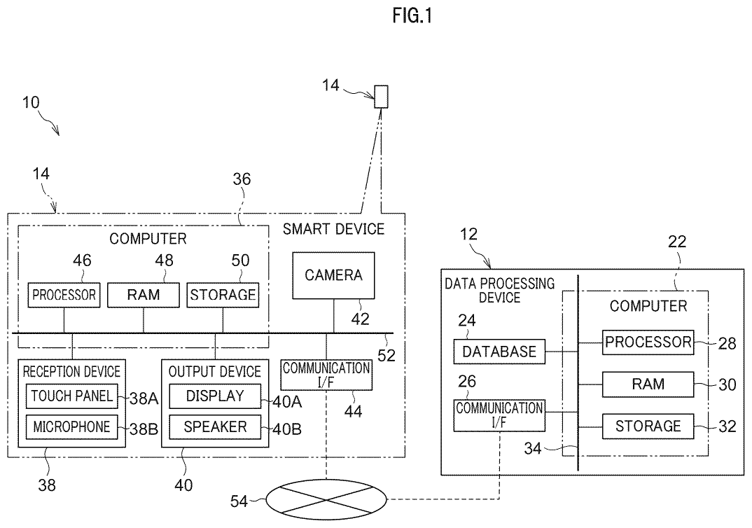

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

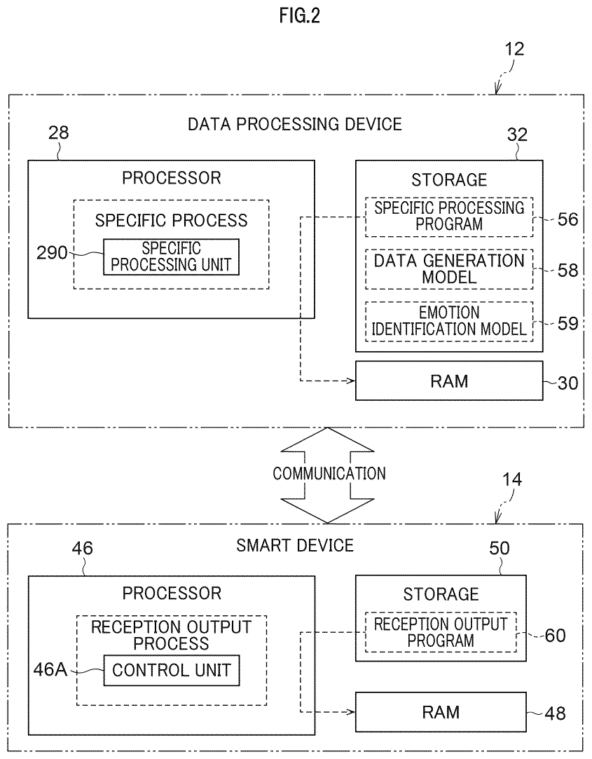

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for managing rights of machine-generated content suffer from several technical deficiencies in how they process, store, and analyze data. First, typical systems record only raw content files and simple metadata in centralized storage. Such architectures make it difficult to prove integrity and existence of content at a particular point in time, and they are vulnerable to unauthorized modification of stored data. As a result, downstream modules cannot reliably determine whether analyzed content corresponds to an original, unaltered version, leading to inconsistent processing outcomes and increased computational overhead for repeated verification. Second, conventional similarity-checking workflows for text, image, and video content are often implemented as loosely coupled or separate services. These services generally operate in batch mode on large data sets, without tight integration with the content ingestion pipeline or with the generative engine that produced the content. Because of this separation, similarity computation is frequently redundant, uses suboptimal feature representations for different data types, and cannot be adaptively controlled based on the actual risk profile of a particular generated item. This results in excessive usage of processor cycles, memory, and communication bandwidth, and delays in notifying users of potentially infringing content. Third, existing generative content platforms typically provide only a one-way interface: a user submits a prompt sentence to a generative AI model, and the platform returns generated content. These platforms rarely have a low-latency, machine-readable feedback loop from a specialized rights-management backend. Consequently, they cannot integrate content registration, tamper-resistant evidence storage, and multi-modal similarity evaluation into the generation flow. This lack of integration prevents the platform from automatically adapting subsequent generations (for example, refining or rejecting a generation) based on objective risk metrics, and forces users to perform manual, error-prone checks using separate tools. Fourth, there is no unified, processor-implemented mechanism that treats content type-specific similarity evaluation (for character information, image information, and video information) and cryptographic fingerprinting plus distributed-ledger recording as parts of a coordinated sequence. In typical systems, hash generation, distributed ledger recording, and similarity analysis are implemented as independent components. This fragmented design leads to multiple, redundant data transformations, uncoordinated error handling, and increased latency between content creation and risk assessment, thereby degrading overall system performance and reliability.

Accordingly, there is a need for a computer-implemented system that technically improves the way a processor ingests and transforms generated content, derives and records cryptographic identification information on a distributed recording infrastructure, generates and queries feature representations appropriate to each media type, computes similarity indices in a unified framework, and returns machine-readable, low-latency risk information to both user terminals and external generative information processing platforms. Such a system should reduce unnecessary data movement and redundant computation, provide tamper-resistant preservation information linked to each item of generated content, and enable integrated control between generation processing and rights-management processing at the level of a processor-executed workflow.

The specific processing by the specific processing unit 290 of the data processing device 12 in Example 1 is realized by the following means.

The present invention provides a server comprising a processor and a memory storing instructions which, when executed by the processor, cause the processor to receive, from a user terminal or an external generative information processing platform, generated information created by a generative information processing apparatus together with attribute information, convert the generated information into fixed-length identification information by reading an entirety of the generated information as a sequence of data and applying a cryptographic summary function to the sequence, store the identification information in association with the attribute information and time information, transmit transaction information including at least the identification information and the time information to a distributed recording infrastructure so that the identification information is recorded in a tamper-resistant manner and acquire recording result information as preservation information, determine an information type of the generated information and, based on the determined type, convert the generated information into feature information as at least one of character-based features, image-based features, and video-based features, compare the feature information with feature information of previously registered reference information to calculate a similarity index, determine, based on the similarity index and a predetermined decision condition, a classification of rights-infringement risk and, when the classification satisfies a threshold, generate and return warning information including at least identification information of the reference information and the similarity index, and provide, based on the similarity index and the preservation information, machine-readable usage permission information or re-generation recommendation information to the generative information processing apparatus via an interface for integrated control of generation processing and rights-management processing. This enables a technically improved, processor-implemented workflow in which cryptographic fingerprinting, distributed-ledger recording, multi-modal feature extraction, and similarity computation are executed as a coordinated sequence tied to each instance of generated information, thereby reducing redundant data processing, improving integrity and verifiability of stored content, lowering latency in risk assessment, and allowing generative platforms to adapt generation behavior in real time based on objective rights-infringement risk metrics.

The term “generated information” refers to information content produced by a generative information processing apparatus, including but not limited to character information, image information, and video information, which is output in response to input such as a prompt sentence.

The term “generative information processing apparatus” refers to an information processing apparatus, such as a generative AI model executed on one or more computers, that receives input including a prompt sentence and automatically generates new information content based on learned patterns.

The term “user terminal” refers to an information processing device operated by a user, including but not limited to a personal computer, a portable terminal, or another communication-capable device, which transmits generated information and receives responses such as warning information.

The term “attribute information” refers to information describing properties of generated information, including but not limited to information type, creation time, creator identifier, format, and source prompt information, which is associated with the generated information for management and processing.

The term “identification information” refers to fixed-length information, such as a cryptographic hash value, that uniquely represents a digital fingerprint of generated information obtained by applying a cryptographic summary function to the entirety of the generated information.

The term “cryptographic summary function” refers to a one-way mathematical function configured to convert an arbitrary-length input sequence into fixed-length output data in such a manner that collisions and reverse reconstruction are computationally difficult, and which is used to generate identification information.

The term “time information” refers to information indicating a time point or time range associated with generated information or identification information, such as a timestamp indicating when the generated information was received or when a transaction was recorded. The term “distributed recording infrastructure” refers to a recording system implemented across a plurality of information processing nodes, such as a distributed ledger or blockchain, which records information in a tamper-resistant and verifiable manner by consensus among the nodes.

The term “transaction information” refers to information configured to be submitted to the distributed recording infrastructure, including at least identification information and time information, and optionally additional metadata, for the purpose of recording such information as a transaction.

The term “preservation information” refers to information obtained from the distributed recording infrastructure as a result of recording transaction information, including but not limited to a transaction identifier, a block identifier, and related verification data, which evidences the existence and integrity of the generated information.

The term “information type” refers to a category assigned to generated information, including at least character information, image information, and video information, which determines how the generated information is converted into feature information.

The term “character information” refers to generated information expressed primarily as a sequence of characters or symbols, such as text data, which can be processed using natural language processing techniques.

The term “image information” refers to generated information expressed primarily as two-dimensional visual data, such as still images or pictures, represented by pixel data or equivalent structures.

The term “video information” refers to generated information expressed as time-varying visual data, such as moving images or motion pictures, typically represented as a sequence of frames accompanied by temporal ordering.

The term “feature information” refers to numerical or structured data that represents characteristics of generated information or reference information, including but not limited to feature vectors, descriptors, or aggregated statistics, used for similarity computation. The term “reference information” refers to information items that have been previously registered in the system as comparison targets, including but not limited to existing works, known copyrighted material, or other baseline content against which generated information is evaluated.

The term “similarity index” refers to a quantitative indicator representing a degree of similarity between feature information of generated information and feature information of reference information, calculated using a predetermined similarity or distance measure. The term “rights-infringement risk” refers to a likelihood, assessed by the system, that use or distribution of generated information may infringe legal or contractual rights associated with reference information, based at least on the similarity index and predetermined conditions. The term “classification of rights-infringement risk” refers to a categorization of the rights-infringement risk into one of a plurality of levels, such as low, medium, or high, determined using the similarity index and a decision condition or threshold.

The term “warning information” refers to information generated by the system when the classification of rights-infringement risk satisfies a threshold, including at least identification information of reference information and the similarity index, and optionally explanatory or guidance information for the user.

The term “usage permission information” refers to information output by the system indicating that generated information may be used under predetermined conditions, based on at least the similarity index and the preservation information.

The term “re-generation recommendation information” refers to information output by the system recommending that the generative information processing apparatus generate alternative content, for example by changing a prompt sentence, in view of an assessed rights-infringement risk.

The term “external generative information processing platform” refers to a platform implemented by one or more servers or services that manages interactions with a generative information processing apparatus, receives prompt sentences and returns generated information, and communicates with the system via a machine-readable interface. The term “communication interface” refers to a logical and physical interface, including network protocols and application programming interfaces, through which the system exchanges data such as generated information, preservation information, and evaluation information with user terminals and external platforms.

The term “evaluation information” refers to information returned by the system to an external generative information processing platform, including at least preservation information and the classification of rights-infringement risk, and optionally additional similarity or usage information.

The term “prompt sentence” refers to instruction information input by a user or platform to the generative information processing apparatus, expressed as natural language or structured commands, that conditions or guides the generation of new information.

In the following embodiments, a server, a terminal, and a user cooperate to implement the claimed system. The server comprises at least one processor and a memory, and executes computer programs stored in the memory. The terminal comprises a processor, a memory, an input device, a display device, and a communication interface. The user operates the terminal to interact with a generative AI model and with the server.

### 1. Overall Configuration

The server runs on hardware such as a general-purpose computing device, for example a rack-mount server or a virtual machine instance in a data center, including a central processing unit (CPU), a volatile memory (RAM), a non-volatile storage device (for example, a solid-state drive), and a network interface controller. The server executes operating system software such as a general-purpose server operating system, and middleware including a web server (for example, software of the nginx type or Apache type), an application framework (for example, software of the Node.js type, Java Spring type, or Python FastAPI type), a relational database management system (for example, software of the PostgreSQL type or MySQL type), and a blockchain client library (for example, a library of the web3 type or a Hyperledger Fabric SDK type).

The terminal runs on hardware such as a personal computer, a smartphone, or a tablet, including a CPU or system-on-chip, RAM, non-volatile storage, a touch panel or keyboard, and a display. The terminal executes an operating system such as a desktop or mobile operating system, and application software such as a web browser (for example, software of the Chrome type or Safari type) or a native application built with a cross-platform framework (for example, software of the React Native type) or platform-specific framework. The user operates the terminal to access a generative AI platform that provides a generative AI model. The generative AI model is implemented as a neural network model, for example a transformer-based language model for text generation, a diffusion-based model for image generation, or a generative video model combining convolutional and recurrent or transformer layers. The generative AI model runs on hardware including graphics processing units (GPUs) or tensor processing units (TPUs) managed by a separate inference server, and is accessed through an application programming interface (API) over a network.

### 2. Generative AI Model and Training

The server does not necessarily train the generative AI model, but the server interoperates with a generative AI model that is trained in advance. A text-generating model is, for example, a transformer architecture including an embedding layer, multiple self-attention blocks, and a feed-forward network. During training, the model minimizes a cross-entropy loss function between predicted token distributions and ground-truth tokens using gradient-based optimization such as stochastic gradient descent with adaptive learning rate (for example, an Adam-type optimizer). The training dataset includes large-scale text corpora, and data augmentation methods such as random masking and shuffling of context segments may be used.

An image-generating model is, for example, a latent diffusion model in which a U-Net-type convolutional neural network maps noisy latent vectors back to clean latent representations, conditioned on text embeddings derived from the prompt sentence. The model is trained by minimizing a mean-squared error loss between predicted and actual noise across multiple noise levels, and weights are updated by back-propagation. Data augmentation such as random cropping, color jitter, and geometric transformations is applied to image training data. A video-generating model is implemented, for example, by extending an image-generating backbone with temporal attention layers or recurrent units to model frame sequences. The model uses an objective function that combines per-frame reconstruction loss and temporal coherence loss, and updates weights by gradient descent.

The server is configured to cooperate with these generative AI models via network calls, and to receive generated information that results from prompt sentences provided by the user or by the terminal.

### 3. Data Structures in the Server

The server stores generated information and associated metadata in structured data records. The server maintains, in the memory or in a database, at least the following logical tables:

(1) A content table that stores, for each piece of generated information, a content identifier, a user identifier, an information type (for example, text, image, video), a storage location pointer (for example, a path or object storage key), a timestamp of receipt, and a reference to an associated hash record.

(2) A hash table that stores, for each content identifier, identification information such as a fixed-length hash value, a hash algorithm identifier (for example, SHA-256 or MD5), a generation time, and flags indicating verification status.

(3) A blockchain evidence table that stores, for each hash record, a network identifier, a transaction identifier, a block identifier, and verification metadata, which form preservation information.

(4) A feature table that stores feature information for both generated information and reference information. For text, the server stores dense vectors of fixed dimension (for example, 768-dimensional embeddings). For images, the server stores either local descriptors (for example, SIFT-type key-point descriptors) or global descriptors obtained from intermediate layers of a convolutional neural network. For videos, the server stores video-level feature vectors derived from aggregating frame-level features.

(5) A similarity result table that stores, for each generated information item, references to one or more reference information items, similarity indices, and a classification of rights-infringement risk.

The server uses these data structures so that cryptographic fingerprinting, distributed-ledger recording, feature extraction, and similarity evaluation are executed without redundant loading or transformation of the same data, thereby reducing memory accesses and improving overall throughput.

### 4. Hash Generation and Distributed Recording

The server uses a cryptographic library, for example a library of the OpenSSL type or a programming language standard cryptographic library, to generate identification information. The server reads content bytes as a continuous sequence into RAM using buffered I/O routines. For each content identifier, the server applies a cryptographic summary function such as SHA-256, which performs repeated compression operations on fixed-size blocks of the input sequence and outputs a fixed-length digest.

The server stores the digest as a hexadecimal string in the hash table and associates it with the content identifier. The server then constructs a transaction data structure that includes the digest, a timestamp, and optionally a content type or user identifier. The server uses a blockchain client library to encode this structure as a transaction payload, sign it with a private key if required by the distributed recording infrastructure, and transmit it over a network to one or more blockchain nodes.

The server receives a transaction identifier and block metadata from the blockchain nodes, and stores this information as preservation information. By recording only the fixed-length digest rather than the entire content, the server reduces network bandwidth usage and storage requirements on the distributed recording infrastructure, while still enabling later proof of integrity by recomputing hashes. This design improves scalability and reduces communication load.

### 5. Feature Extraction for Text

The server uses a natural language processing library, for example software of the spaCy type or NLTK type, to process character information. The server first normalizes text by lowercasing characters, removing redundant whitespace, and optionally applying Unicode normalization. The server then splits text into tokens using a tokenizer consistent with the vocabulary of an embedding model.

The server uses either a term frequency-inverse document frequency (TF-IDF) method implemented in a machine learning library such as scikit-learn, or a pre-trained transformer-based encoder (for example, a Sentence-BERT-type model) to convert token sequences into feature vectors. In the TF-IDF case, the server constructs a sparse vector whose components correspond to vocabulary items and whose values represent term importance. In the transformer-based case, the server feeds tokenized text into the encoder; the encoder applies multi-head self-attention and feed-forward layers to produce contextual embeddings, and the server computes a pooled representation (for example, a [CLS] token vector or an average of token vectors) as the feature vector.

The server stores the resulting feature vector in the feature table and, optionally, in a vector index structure such as a library of the FAISS type. The use of dense or sparse vector representations allows similarity computation to be performed using efficient linear algebra operations on the processor, improving speed and accuracy over naive string matching or simple n-gram comparisons.

### 6. Feature Extraction for Images

The server uses an image processing library such as OpenCV or Pillow to load image information into memory as pixel arrays. The server converts each image to a fixed resolution and standard color space, for example RGB at 224×224 pixels, to ensure consistent input to feature extraction algorithms.

In one embodiment, the server extracts local features using a keypoint-based algorithm such as SIFT or SURF. The server detects keypoints, computes descriptors for each keypoint, and represents an image as a set of high-dimensional descriptor vectors. The server then applies a vector quantization or bag-of-visual-words scheme to convert these descriptors into a fixed-length histogram vector, which is stored as feature information.

In another embodiment, the server loads a pre-trained convolutional neural network, for example a ResNet-type or VGG-type architecture trained on large image datasets. The server removes the final classification layer and uses an intermediate layer output as a global feature vector. The server forwards each normalized image through the network; the network performs convolution, pooling, and non-linear activation operations to produce feature maps, and the server applies a global average pooling to obtain a compact descriptor. This non-linear processing captures complex patterns of shape, texture, and color that are not easily described by simple handcrafted rules.

By using these specific feature extraction techniques, the server reduces the dimensionality of image data while preserving discriminative information relevant to similarity, thereby enabling more efficient indexed search in high-dimensional space and reducing CPU and memory usage compared to operating on raw pixels.

### 7. Feature Extraction for Videos

The server uses a multimedia processing tool such as FFmpeg, invoked through a library or system call, to decode video information into a sequence of frames at predetermined temporal intervals, for example one frame per second. The server loads each sampled frame into memory as an image and applies the same image feature extraction pipeline described above. The server then aggregates frame-level feature vectors into a video-level feature. Aggregation methods include temporal averaging, weighted pooling based on frame saliency scores, or temporal attention mechanisms learned by an auxiliary model. The server stores the aggregated vector as the video feature. This step transforms large video files into compact representations that preserve temporal structure while significantly reducing data volume, thereby decreasing storage consumption and accelerating similarity search.

### 8. Similarity Computation and Risk Classification

The server computes a similarity index between generated information and reference information by performing vector comparisons. For text, the server computes cosine similarity between feature vectors using linear algebra libraries optimized for CPU vector instructions. For images and videos, the server computes either cosine similarity or Euclidean distance on real-valued vectors, and may convert distances into similarity scores via a monotonically decreasing function.

The server retrieves candidate reference information vectors from the feature table using an approximate nearest neighbor index, for example a library of the FAISS type. The server then refines similarity scores by computing exact distances on a smaller candidate set. This two-stage search architecture reduces the number of exact distance calculations and lowers CPU load, while maintaining high recall in similarity detection.

The server applies predetermined thresholds and decision conditions to the similarity index. For example, the server maps a similarity index above a first threshold to a “high risk” classification, between first and second thresholds to a “medium risk” classification, and below the second threshold to a “low risk” classification. The server may further incorporate other factors such as the number of high-similarity matches or the distribution of similarities across multiple reference items.

By implementing this classification in a deterministic algorithm on the server, the system avoids reliance on subjective human interpretation and allows the processor to make consistent, reproducible decisions at scale.

9. Interaction with Generative AI Model Through Prompt Sentences

The user operates the terminal to interact with the generative AI model by inputting a prompt sentence. The terminal provides a text input field in a graphical user interface. The user enters prompt sentences such as:

“Please generate the opening of a fantasy novel set in a medieval magical kingdom.” “Please draw an impressionist-style landscape painting of a lakeside at sunset.” “Please create a short video set in a futuristic city with flying cars and neon lights.” “Please generate the opening of a fantasy novel set in a medieval magical kingdom, with unique magic rules and original characters.”

“Please create a short video set in a futuristic city that differs significantly from existing famous science fiction movies.”

The terminal sends these prompt sentences via HTTPS to a generative AI platform. The generative AI model processes the prompt sentence by tokenizing the text, mapping tokens to embeddings, and applying multiple layers of attention or diffusion steps depending on the model type. The model outputs generated information in the form of text, image, or video data.

The terminal receives the generated information and, under user control, transmits it to the server for rights-management processing. By inserting the server's workflow immediately after generation, the system can provide low-latency technical feedback regarding similarity and risk, enabling real-time adaptation in the generative process. 10. Cooperation between server, terminal, and user

The user selects generated information for analysis via a file selection dialog or a content list display on the terminal. The terminal reads the selected file from local storage into memory and uploads it to the server via an HTTP POST request with multipart/form-data. The terminal also sends metadata such as information type, file size, and an identifier of the prompt sentence used.

The server receives the upload, stores the file in a storage backend such as a local file system or object storage, and updates the content table. The server then generates identification information, records it to the distributed recording infrastructure, extracts features, computes similarity, and classifies risk as described above.

The terminal receives a response from the server containing warning information, preservation information, and, if applicable, usage permission information or re-generation recommendation information. The terminal displays this information to the user in a structured format, for example listing the most similar reference items and their similarity indices, and indicating whether the server recommends re-generation.

The user reviews the information and may decide to modify the prompt sentence or add constraints to produce less similar content. The user then resubmits a new prompt sentence to the generative AI model, and the cycle repeats. This loop allows the user to use the system as a technical tool to improve originality and reduce infringement risk, guided by machine-computed metrics.

### 11. Technical Effects and Improvement of Computer Technology

The server improves computer technology in several specific ways. First, by tightly coupling cryptographic hash generation, distributed-ledger recording, and feature-based similarity computation in a single processor-implemented workflow, the server reduces redundant data loading and transformation. The server reads content bytes only once into memory for hashing and storage; feature extraction modules then access the stored file via a reference, preventing multiple network transmissions or disk reads of the same data. This reduces cache misses and I/O overhead, thereby improving processing speed and throughput.

Second, by using media-specific feature extraction algorithms (for example, transformer-based text encoders, CNN-based image encoders, and aggregated frame features for videos), the server transforms high-volume raw data into compact feature vectors that reside in RAM and are processed in vectorized operations. This structure enables highly parallel similarity computations using CPU vector instructions and optimized BLAS-type libraries, leading to lower latency and reduced energy consumption compared to naive per-byte or per-pixel comparison.

Third, by storing only hash values on the distributed recording infrastructure, the server reduces communication bandwidth and on-chain storage requirements, while still enabling strong integrity guarantees. This design reduces transaction sizes and allows the distributed recording infrastructure to handle a higher transaction rate without congestion, which is a computer-technical improvement over storing full payloads.

Fourth, by providing machine-readable risk classifications and preservation information via an API to an external generative information processing platform, the server enables that platform to automatically adjust generation behavior, for example by modifying sampling temperatures, re-weighting prompt conditioning, or applying additional regularization when high risk is detected. This feedback loop is implemented at the level of model parameters and sampling procedures, and results in fewer repeated generations and reduced overall computation, showing a concrete improvement in system-wide computational efficiency.

Fifth, the server employs deterministic, algorithmic decision rules based on quantitative similarity indices and thresholds, rather than simply automating a manual human review process. The server uses non-conventional combinations of cryptographic hashing, vector-space similarity search, and distributed-ledger recording, in a specific procedural order, to achieve low-latency and high-accuracy detection of potentially infringing similarities. This combination is not a mere automation of known human intellectual tasks, but a new technical arrangement that improves how computers store, index, and retrieve information at scale.

### 12. Variations and Alternative Embodiments

The server may employ different hash algorithms (for example, SHA-3-type algorithms) depending on required security levels. The server may choose between public blockchain networks and permissioned distributed ledgers, or use a sidechain configuration to reduce transaction fees and latency.

The server may use alternative feature extraction architectures. For text, the server may use recurrent neural networks or convolutional sequence models instead of transformer encoders. For images, the server may use vision transformer architectures that treat image patches as tokens. For videos, the server may use three-dimensional convolutional networks that directly process spatiotemporal cubes of pixels. The server may also employ metric-learning techniques that train an embedding function specifically to separate reference information by rights status, using contrastive loss functions.

The server may adjust thresholds and decision conditions dynamically based on observed false positive and false negative rates, which the server can estimate from historical feedback data. The server may store auxiliary statistics such as similarity distributions and use them to adapt risk classification boundaries over time. These adaptations are carried out algorithmically and modify how the processor evaluates future content, thereby further improving accuracy and stability.

The terminal may be implemented as a browser-based client using JavaScript frameworks, or as a native application that uses a platform-specific network library. The terminal may perform pre-processing, such as client-side compression of images or videos, to reduce upload size and communication load, while still preserving sufficient quality for server-side feature extraction.

The user may integrate the system into various technical applications such as digital content creation tools, automated video editing systems, or interactive story-generation platforms. In each case, the server performs the same core technical operations-cryptographic fingerprinting, distributed-ledger recording, multi-modal feature extraction, and similarity-based risk evaluation-using specific data structures and algorithms as described above, thereby enabling reliable, efficient, and scalable rights management for content generated by a generative AI model based on prompt sentences.

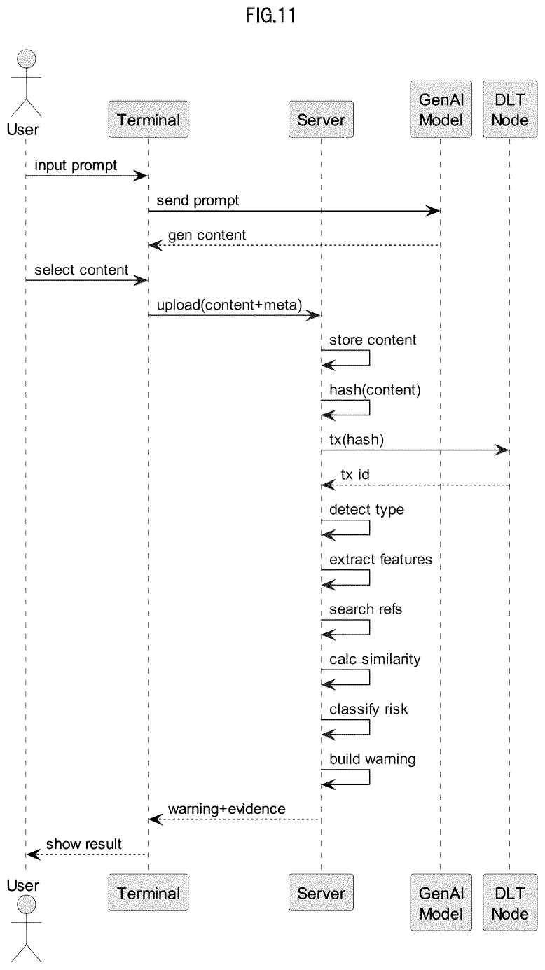

The following describes the processing flow using FIG. 11.

### Step 1:

The user operates the terminal to input a prompt sentence and request generation.

The user enters, as input, a prompt sentence such as “Please generate the opening of a fantasy novel set in a medieval magical kingdom.”, “Please draw an impressionist-style landscape painting of a lakeside at sunset.”, or “Please create a short video set in a futuristic city with flying cars and neon lights.” into a text field displayed on the terminal.

The terminal takes this prompt sentence as input data, encodes it into a request payload (for example, JSON containing the prompt text and generation parameters), and sends the payload via HTTPS to a generative AI model API endpoint.

The generative AI model returns, as output, generated information in the form of text, image, or video data, which the terminal receives, decodes (for example, parses JSON, decodes base64 image data, or stores video bytes), and temporarily stores in local memory or local storage.

### Step 2:

The terminal presents generated information and collects user selection for analysis. The terminal takes, as input, the generated information received from the generative AI model and associated metadata (for example, content type, file size, and used prompt sentence). The terminal displays, as output, the generated text in a text viewer, the generated image in an image viewer, or the generated video in a media player, and shows selectable controls (for example, a checkbox or button) labeled as “Send for copyright analysis” or equivalent. The user selects, as input to the next operation, one or more generated items for rights management by clicking or tapping on the corresponding control, and the terminal records this selection as an internal state.

### Step 3:

The terminal prepares and sends an upload request to the server.

The terminal takes, as input, the selected generated information file and its metadata (for example, user identifier, information type, prompt sentence text, and timestamp). The terminal reads the file bytes into memory, builds an HTTP POST request body (for example, multipart/form-data where one part contains raw file bytes and another part contains JSON metadata), and sets appropriate headers (for example, content type and authentication token).

The terminal sends, as output, the completed HTTP request to a server endpoint such as “/api/content/upload” via a secure network connection.

### Step 4:

The server receives and stores the uploaded generated information.

The server takes, as input, the HTTP POST request containing file bytes and metadata from the terminal.

The server parses the request body, validates the authentication token, checks file size and content type constraints, and extracts the raw byte stream of the generated information into server memory.

The server writes, as output, the raw byte stream to a persistent storage layer (for example, a file system path or an object storage bucket), generates a unique content identifier, and stores a new record in a content table linking the content identifier to the user identifier, information type, prompt sentence, and storage location.

### Step 5:

The server generates cryptographic identification information (hash value).

The server takes, as input, the stored content identifier and corresponding file location from the content table.

The server reads the file data as a sequential byte stream into RAM, and applies a cryptographic hash function (for example, SHA-256) using a cryptographic library. The server processes the byte stream in fixed-size blocks, updates an internal hash state for each block, and finally computes a fixed-length digest.

The server stores, as output, the generated digest (identification information) in a hash table, associated with the content identifier, and records in the table which hash algorithm was used and the time of hash generation.

### Step 6:

The server records the hash value on a distributed recording infrastructure.

The server takes, as input, the identification information (hash value), the content identifier, and time information from the hash table.

The server constructs transaction information that includes at least the hash value and time information, and optionally content type and user identifier, and encodes this transaction using a blockchain client library. The server signs the transaction with a local private key if required and transmits it to one or more nodes of a distributed ledger network.

The server receives, as output, a transaction identifier and block metadata (for example, block hash and block number) from the network, verifies that the transaction has been included in a block, and stores this preservation information in a blockchain evidence table linked to the content identifier.

### Step 7:

The server determines the information type and loads the generated information for feature extraction.

The server takes, as input, the content identifier and its associated information type (for example, “text”, “image”, or “video”) from the content table.

The server reads the stored file from persistent storage into memory based on the storage location pointer. For text, the server loads the file as a string; for images, the server loads the file as a pixel matrix; for videos, the server loads the file for frame decoding

The server outputs a normalized in-memory representation of the generated information suitable for subsequent feature extraction (for example, Unicode text, RGB image array, or decoded video stream), together with the identified information type.

### Step 8:

The server extracts feature information from text-type generated information.

The server takes, as input, the character information (text string) and the information type indicating text.

The server normalizes the text (for example, lowercasing and removing extra whitespace), tokenizes it into word or subword units using a natural language processing tokenizer, and converts the tokens into numerical vectors using either a TF-IDF algorithm or a pre-trained transformer encoder. In the TF-IDF case, the server computes term frequencies and multiplies them by inverse document frequencies; in the transformer case, the server computes contextual embeddings and aggregates them into a fixed-length feature vector.

The server stores, as output, the resulting text feature vector in a feature table, associated with the content identifier and a feature type indicating text.

### Step 9:

The server extracts feature information from image-type generated information.

The server takes, as input, the image information (pixel matrix) and the information type indicating image.

The server resizes the image to a predefined resolution, converts it to a standard color space (for example, RGB), and either detects key points and computes local descriptors using a feature algorithm (for example, SIFT) or passes the normalized image through a pre-trained convolutional neural network and extracts intermediate-layer activations as a global descriptor. When using local descriptors, the server aggregates them into a fixed-length histogram via vector quantization; when using a neural network, the server applies global pooling to obtain a compact vector.

The server stores, as output, the resulting image feature vector in the feature table, associated with the content identifier and a feature type indicating image.

### Step 10:

The server extracts feature information from video-type generated information. The server takes, as input, the video information (encoded file) and the information type indicating video.

The server uses a multimedia processing tool to decode the video and sample frames at predefined time intervals. For each sampled frame, the server converts it to an image array and applies the same image feature extraction pipeline used for image information, generating frame-level feature vectors. The server then aggregates the frame-level vectors over time (for example, by averaging or weighted pooling) to produce a single video-level feature vector.

The server stores, as output, the aggregated video feature vector in the feature table, associated with the content identifier and a feature type indicating video.

### Step 11:

The server retrieves reference feature information and computes similarity indices.

The server takes, as input, the feature vector of the generated information from the feature table and the information type, which determines which reference set to query (for example, text corpus, image database, or video catalog).

The server queries an index of reference feature vectors (for example, a vector database or an approximate nearest neighbor index) using the feature vector as a query, and retrieves a set of candidate reference vectors along with their identifiers. The server then computes similarity measures, such as cosine similarity or Euclidean distance, between the generated feature vector and each candidate reference vector using linear algebra routines.

The server outputs, for each candidate reference item, a similarity index and the corresponding reference identifier, and stores these in a similarity result table linked to the content identifier.

### Step 12:

The server classifies rights-infringement risk based on similarity indices.

The server takes, as input, the list of similarity indices and reference identifiers from the similarity result table for the content identifier.

The server compares each similarity index with predefined thresholds and evaluates aggregated criteria, such as the maximum similarity index and the number of indices exceeding certain levels. The server then maps these numerical measures to a risk classification level (for example, low, medium, or high) using a stored decision rule.

The server stores, as output, the determined risk classification and the most similar reference identifiers in the similarity result table, and prepares structured evaluation data including risk level, top similarity indices, and associated reference information.

### Step 13:

The server generates warning information and usage or re-generation recommendations. The server takes, as input, the risk classification, the similarity indices, and the preservation information linked to the content identifier.

The server checks whether the risk classification is greater than or equal to a predefined warning threshold. If the threshold is met, the server constructs warning information that includes at least the top reference identifiers, their similarity indices, and an explanation of potential rights-infringement risk. The server also generates either usage permission information (for example, when risk is low) or re-generation recommendation information (for example, when risk is high), indicating whether the user should modify the prompt sentence or regenerate the content.

The server sends, as output, a response payload containing the warning information, preservation information, and usage or re-generation recommendations to the terminal or, in the case of API integration, to an external generative information processing platform.

### Step 14:

The terminal receives and displays the server's evaluation to the user.

The terminal takes, as input, the response payload from the server that includes warning information, preservation information, and recommendation information.

The terminal parses the payload, extracts key elements such as risk classification, top similar reference items, similarity indices, and blockchain transaction identifiers, and organizes them into human-readable display elements. The terminal renders, as output, a user interface screen showing, for example, a risk level indicator, a list of similar works, and a message such as “High similarity detected; please consider changing the prompt sentence.”

The user views the displayed information and, based on the recommendations, decides whether to accept the current generated information or to modify the prompt sentence and initiate a new generation cycle.

### Step 15:

The server interacts with an external generative information processing platform via an API. The server takes, as input, a machine-readable processing request from an external generative information processing platform, where the request includes generated information, attribute information, and optionally the original prompt sentence.

The server automatically executes, based on this input, the same internal operations described in Steps 4 through 13, including storage, hash generation, distributed recording, feature extraction, similarity computation, and risk classification, without requiring manual intervention. The server then forms evaluation information containing preservation information and the risk classification and encodes it as an API response.

The server outputs the evaluation information to the external platform, which can then programmatically decide whether to serve the generated information to end users, adjust generation parameters, or request re-generation from its own generative AI model.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content management systems that handle works generated with generative artificial intelligence models generally treat such works as ordinary digital files and merely perform simple file registration, optional hashing, or basic plagiarism checks. These conventional systems suffer from several technical deficiencies when deployed in modern networked computing environments.

First, conventional systems do not tightly couple the generated content data with the prompt sentence data that was supplied to the generative artificial intelligence model. As a result, downstream processing nodes in a distributed system cannot reconstruct the causal relationship between user input and generated output. This prevents the computing system from programmatically guiding a user to refine the prompt sentence in a way that technically reduces similarity to existing works, and it forces human operators to manually inspect content and adjust prompts in an ad hoc manner. This lack of structured linkage between prompts and generated content leads to inefficient use of processing resources and increased network traffic due to repeated, unguided content generation and re-upload cycles. Second, conventional systems commonly compute hashes on raw files and store such hashes in local databases without standardized normalization or robust, tamper-resistant storage. Without content-type-aware normalization and without a distributed ledger, identical or near-identical content encoded in slightly different formats can produce different hashes, which degrades the accuracy of deduplication and provenance tracking. Moreover, storing hashes only in a conventional centralized database makes the record of content existence vulnerable to tampering or unauthorized modification, thereby reducing the technical reliability of integrity verification within a distributed computing environment.

Third, existing similarity checking techniques are often implemented as isolated tools that handle only a single data type or use simplistic string matching or pixel comparison. They frequently do not employ a unified feature-vector-based framework that can handle text, image, audio, and video content in a scalable, index-friendly way. Consequently, when a large volume of heterogeneous generated content is processed, the similarity checking subsystem can become a computational bottleneck, suffer from low recall or precision, and consume excessive memory and CPU resources. Additionally, conventional systems seldom expose a consistent application programming interface that allows external content distribution platforms and generative artificial intelligence platforms to invoke copyright management and similarity checking as part of their own real-time workflows, which results in duplicated implementations and fragmented data flows across multiple servers.

Fourth, even when similarity is detected, conventional systems typically output simple notification messages that a match exists, without correlating similarity results back to the original prompt sentence or providing machine-generated guidance on how to modify the prompt sentence to technically reduce similarity metrics. This leads to unnecessary reprocessing, since the generative model is often re-invoked with only minor or uninformed changes to the prompt, increasing computational load on servers hosting the generative artificial intelligence models and on networking infrastructure.

Accordingly, there is a need for an improved computer-implemented system that: (i) systematically acquires and associates generated content data with corresponding prompt sentence data; (ii) performs content-type-aware normalization and hash calculation and records the resulting hash values in a distributed ledger to enhance integrity and provenance tracking; (iii) generates multi-modal feature vector sets for text, image, audio, and video content and efficiently compares those feature vectors against a database of existing copyrighted works; and (iv) generates structured warning information that includes prompt-level guidance to support iterative, technically-directed refinement of content generation. Such a system should further expose an application programming interface that allows external platforms to offload copyright management logic to a dedicated server, thereby improving overall computational efficiency, scalability, and reliability of content generation and distribution workflows in networked computing environments.

The specific processing by the specific processing unit 290 of the data processing device 12 in Application Example 1 is realized by the following means.

The present invention provides a server comprising a processor configured to acquire generated content data and corresponding prompt sentence data from a terminal, associate the generated content data and the prompt sentence data with identification information, store the associated data in a storage, and read out the generated content data based on the identification information; to execute normalization processing on the generated content data in accordance with a type of the generated content data and to sequentially apply a hash function to the normalized content so as to generate a hash value representing a digital fingerprint of the generated content data; to generate transaction data including the hash value and transmit the transaction data to a distributed ledger node so that the hash value is recorded in a block of a distributed ledger in a tamper-resistant manner; to generate, in accordance with the type of the generated content data, a set of feature vectors of the generated content data by performing vectorization processing using a natural language processing algorithm for text data, performing feature extraction using an image feature extraction algorithm for image data, and extracting time-frequency features or frame features for audio data or video data; to compare the generated set of feature vectors with a set of feature vectors of existing copyrighted works registered in an existing work database by using a vector similarity calculation algorithm, calculate a similarity index between the generated content data and each existing copyrighted work, and extract, as similarity candidates, existing copyrighted works for which the similarity index exceeds a threshold; to generate warning information data including copyright information corresponding to the similarity candidates, the similarity index, matching section information, and the prompt sentence data together with guidance information for modifying the prompt sentence data so as to reduce the similarity index, and transmit the warning information data to the terminal so that the terminal presents information prompting iterative modification of the prompt sentence data and re-generation of the generated content data by a generative artificial intelligence model; and to provide an application programming interface that, in response to a processing request from an external content distribution platform or an external generative artificial intelligence platform, allows at least one of content upload, hash value generation, distributed ledger recording, and similarity checking to be invoked as a service by the external platform. This enables an improvement of computer technology by structurally linking prompt sentence data and generated content data, by performing content-type-aware normalization and tamper-resistant hash recording to enhance integrity verification, by executing multi-modal feature-vector-based similarity analysis in a scalable manner across heterogeneous media types, and by programmatically guiding iterative prompt refinement through a server-side application programming interface, thereby reducing redundant computation, improving accuracy and efficiency of copyright risk assessment, and enhancing reliability and scalability of content generation and distribution workflows executed by computer systems.

The term “generated content data” refers to digital data representing output produced by a generative artificial intelligence model, including but not limited to text, image, audio, and video data, that is suitable for storage, transmission, and further processing by a computer system.

The term “prompt sentence data” refers to digital data representing one or more user-provided natural language expressions, commands, or instructions that are supplied to a generative artificial intelligence model as input to control or influence generation of the generated content data.

The term “terminal” refers to an information processing apparatus operated by a user, such as a client computer, mobile device, or other user interface device, that is configured to transmit prompt sentence data and generated content data to a server and to receive and display warning information data.

The term “identification information” refers to digital data, such as an identifier or key, that is used by a computer system to uniquely associate, index, or retrieve related data items, including generated content data and prompt sentence data, from a storage.

The term “storage” refers to one or more memory devices or storage subsystems, such as volatile memory, non-volatile memory, or external storage systems, that are configured to store generated content data, prompt sentence data, hash values, feature vectors, and related metadata in a manner accessible to a processor.

The term “normalization processing” refers to a series of computer-implemented operations executed on generated content data, the operations being selected in accordance with a type of the generated content data, such as text, image, audio, or video, to convert the generated content data into a standardized or canonical form suitable for consistent hash calculation or feature extraction.

The term “hash function” refers to a deterministic algorithm executed by a processor that receives digital data as input and outputs a fixed-length hash value, such that small changes in the input cause large, pseudo-random changes in the output and collisions between different inputs are computationally difficult to find.

The term “hash value” refers to a fixed-length digital representation generated by applying a hash function to digital data, the hash value serving as a digital fingerprint for the input data for purposes including integrity verification, deduplication, and provenance tracking.

The term “digital fingerprint” refers to a hash value or similar compact digital representation that uniquely identifies digital data with high probability and is used by a computer system to detect tampering, duplication, or substitution of the digital data.

The term “distributed ledger” refers to a computer-implemented data structure, replicated across multiple nodes in a network and maintained by a consensus protocol, in which transaction data, including hash values, are recorded in a manner that is verifiable and resistant to tampering or unauthorized modification.

The term “distributed ledger node” refers to a computing device participating in maintenance of a distributed ledger, the computing device being configured to receive transaction data, validate the transaction data according to a consensus protocol, and record the transaction data in blocks of the distributed ledger.

The term “transaction data” refers to digital data formatted in accordance with a protocol of a distributed ledger system and including, at least, a hash value and control information, the transaction data being transmitted to a distributed ledger node for recording in a block. The term “feature vector” refers to an ordered numerical representation of properties of content data, such as text, image, audio, or video data, wherein each element of the vector encodes a particular feature or characteristic extracted from the content by an algorithm. The term “set of feature vectors” refers to one or more feature vectors collectively representing different aspects, segments, or modalities of generated content data or existing copyrighted works, such that the set can be used for similarity computation by a computer system.

The term “natural language processing algorithm” refers to a computer-implemented procedure or model configured to analyze or process text data, including tokenization, embedding generation, or vectorization, to convert the text data into a numerical representation suitable for similarity computation or other downstream processing. The term “image feature extraction algorithm” refers to a computer-implemented procedure configured to process image data or frame data to derive numerical features, including but not limited to local descriptors or deep feature vectors, that capture visual characteristics for similarity analysis.

The term “time-frequency features” refers to numerical descriptors derived from audio data or audio sections of video data that represent distribution of signal energy over time and frequency, such as spectrogram-based features or cepstral coefficients, and that are used for similarity assessment.

The term “frame features” refers to numerical descriptors derived from individual frames or sequences of frames of video data that represent visual characteristics, and that are used as feature vectors for similarity analysis of video content.

The term “vector similarity calculation algorithm” refers to a computer-implemented method configured to compute a similarity index or distance between feature vectors or sets of feature vectors, including but not limited to cosine similarity, Euclidean distance, or other metric functions.

The term “similarity index” refers to a quantitative value computed by a vector similarity calculation algorithm that represents a degree of similarity or difference between generated content data and an existing copyrighted work, the value being used for threshold-based determination of similarity candidates.

The term “existing copyrighted work” refers to digital content previously registered or stored in an existing work database, including text, image, audio, or video data, that is subject to copyright protection and serves as a reference for similarity comparison.

The term “existing work database” refers to a data storage structure, implemented in a computer system, that stores existing copyrighted works and associated feature vectors, identifiers, and metadata, and that is searchable for similarity comparison.

The term “similarity candidate” refers to an existing copyrighted work selected by a computer system as a result of similarity comparison, for which a similarity index with respect to generated content data exceeds a predetermined threshold.

The term “matching section information” refers to data indicating portions, intervals, or segments of generated content data and corresponding portions, intervals, or segments of an existing copyrighted work that contribute to a similarity index and are identified as matching or highly similar.

The term “warning information data” refers to structured digital data generated by a processor that includes at least information identifying similarity candidates, similarity indices, matching section information, and optionally prompt sentence data and guidance information, the data being transmitted to a terminal for display to a user.

The term “guidance information” refers to digital data representing automatically generated instructions, suggestions, or indications provided to a user for modifying prompt sentence data or other input parameters so as to reduce a similarity index between generated content data and existing copyrighted works.

The term “application programming interface” refers to a set of callable endpoints, message formats, and protocols exposed by a server, allowing external systems to invoke server-side functions, including content upload, hash value generation, distributed ledger recording, and similarity checking, over a communication network.

The term “external content distribution platform” refers to a computer-implemented system operated independently of the server, configured to distribute or publish digital content to end users, and capable of invoking the application programming interface of the server for copyright management.

The term “external generative artificial intelligence platform” refers to a computer-implemented system that provides generative artificial intelligence services, including content generation based on prompt sentence data, and that is capable of invoking the application programming interface of the server to perform copyright-related processing on generated content data.

The term “generative artificial intelligence model” refers to a machine learning model or neural network configured to generate content, including text, image, audio, or video data, in response to input data such as prompt sentence data.

In one embodiment, a server, a plurality of terminals, and one or more external platforms cooperate to implement the claimed system. The server includes at least one central processing unit (CPU), an optional graphics processing unit (GPU), a main memory, a non-volatile storage device, a network interface, and a set of executable software modules. The terminals include general-purpose client devices, such as desktop computers, notebook computers, smartphones, or tablet devices, each having a processor, a memory, a display device, an input device, and a communication module. The external platforms include a content distribution platform and a generative artificial intelligence platform, each implemented as a computer system connected to the server via a communication network such as the Internet.

The server executes an operating system such as a general-purpose server operating system, a web application framework such as an HTTP server and an application framework, a database management system such as a relational database, and various application modules implementing the functions of acquiring generated content data and prompt sentence data, performing normalization and hash computation, interacting with a distributed ledger, performing similarity analysis, and generating warning information and guidance. The server optionally uses a deep learning framework such as a general-purpose tensor computation framework running on a GPU to execute feature extraction models for text, image, audio, or video.

The terminal executes a client operating system, a graphical user interface layer, and either a web browser or a native application that communicates with the server via a secure communication protocol such as HTTPS. The terminal presents user interface screens for inputting a prompt sentence, uploading generated content data to the server, and displaying warning information and guidance returned from the server. The user operates the terminal by inputting prompt sentence data, confirming generated content data, and selecting actions based on warning information, such as modifying the prompt sentence or cancelling content publication.

The user operates the terminal and interacts with a generative AI model provided either locally or by an external generative artificial intelligence platform. The user inputs a prompt sentence to control generation of content. Example prompt sentences include: “Please generate the opening of an adventure story set in a medieval magical kingdom.”

“Please draw an impressionist-style landscape painting.” “Please create a short video set in a futuristic city.” “Please compose a melody in the style of 1980s synth-pop.”

“Please compose an original, royalty-free melody inspired by 1980s synth-pop, clearly different from any existing commercial tracks.”

“Please generate the opening of an adventure story set in a medieval magical kingdom, ensuring it is original and not similar to existing famous fantasy novels.”

“Please draw an original impressionist-style landscape that does not reproduce any existing well-known painting.”

“Please create a short video set in a futuristic city with unique scenes that do not imitate specific movies or anime.”

The terminal transmits the prompt sentence data to the generative AI model. In one embodiment, the generative AI model is a neural network model having a transformer architecture for text and an encoder-decoder architecture for images or video. The model includes multiple layers of self-attention units, feed-forward layers, and normalization layers. The model parameters are stored as multidimensional numeric tensors and are updated during a prior training phase using supervised or self-supervised learning. During that training phase, a training processor minimizes a loss function such as cross-entropy loss or mean squared error by backpropagation and gradient-based optimization, and performs data augmentation such as random cropping for images or time stretching for audio, thereby enabling the model to learn generalized patterns from large training datasets.

During inference, the model receives the prompt sentence data, encodes the text into token IDs, maps the token IDs to embeddings, and processes the embeddings through stacked attention and feed-forward blocks to produce probability distributions over output tokens (for text) or latent image or video features (for images and video). The model applies non-linear activation functions and softmax layers to generate output sequences or pixel values. The generative AI model thus performs numerical operations that are not feasible for manual human processing, such as high-dimensional matrix multiplications and optimized tensor operations on a GPU, and thereby generates the generated content data in a computationally efficient manner.

The terminal receives the generated content data from the generative AI model and stores the generated content data in a file system or application storage. The terminal associates local metadata such as a local identifier, content type, and the original prompt sentence data with the stored file. The terminal transmits the generated content data and the prompt sentence data to the server over the network using an application-level protocol. In one embodiment, the terminal uses HTTPS and sends the data in a multipart or structured request body. The server receives the generated content data and prompt sentence data via a network interface and an HTTP server module. The server executes a data acquisition module that parses the incoming request, extracts the generated content data and the prompt sentence data, and assigns identification information such as a unique content identifier. The server stores the generated content data in a non-volatile storage device, such as a disk array or an object storage system, and stores the prompt sentence data and the identification information in a database table. The server thereby maintains a structured linkage between each generated content and the corresponding prompt sentence data. This linkage enables the server to later generate guidance that directly references the original prompt sentence and to support iterative refinement in a machine-assisted manner.

The server performs normalization processing on the generated content data before hashing. For text data, the server applies a text normalization module that unifies character encoding to a standard encoding, normalizes line endings, and optionally converts full-width and half-width characters or normalizes white space sequences. For image data, the server uses an image processing library to convert the image data into a standard color space, resize the image to a standard resolution, and optionally apply noise reduction. For video data, the server invokes a multimedia processing module that decodes the video into frames, extracts key frames at pre-defined intervals or based on scene change detection, resizes the frames, and normalizes pixel values. For audio data, the server resamples the audio to a standard sampling rate and bit depth and normalizes amplitude levels. This normalization processing ensures that content representing the same or highly similar visual or auditory information yields consistent input to the hash function and to the feature extraction modules, even if encoding formats or low-level representations differ.

The server executes a hash computation module that receives the normalized generated content data as a stream of bytes and applies a cryptographic hash function such as a secure hash algorithm. The server reads the normalized data in fixed-size blocks to avoid excessive memory usage and updates the hash state for each block. After all blocks are processed, the server finalizes the hash function and obtains a hash value representing a digital fingerprint of the normalized generated content data. The server stores the hash value in the database in association with the content identifier and the prompt sentence data.

The server transmits the hash value to a distributed ledger node by constructing transaction data according to the protocol of a distributed ledger system. The server signs the transaction data with a private key stored in a secure module and sends the signed transaction via a network interface to the distributed ledger node. The distributed ledger node validates the transaction by executing consensus logic and records the transaction in a block. The server receives a transaction identifier and a block number and stores them in the database. Because the hash value is stored in a distributed ledger, any subsequent modification of the generated content data can be detected by recalculating the hash value and comparing it with the value stored on the distributed ledger. This enhances integrity verification and provides a tamper-resistant proof of existence. At the system level, this reduces the need for repeated large-volume archival storage or repeated full comparisons of content when verifying provenance, thereby improving storage efficiency and verification speed.

The server executes a feature extraction module to generate a set of feature vectors for the generated content data. For text data, the server uses a natural language processing submodule. In one embodiment, the server uses a transformer-based text encoder trained to output sentence embeddings. The server tokenizes the text using a tokenizer that splits the text into sub-word units, maps tokens to embeddings via an embedding matrix, and processes the sequence through multi-head self-attention layers and feed-forward layers to produce a fixed-dimensional vector representing the semantic content of the text. The server optionally uses term frequency-inverse document frequency (TF-IDF) vectors or other weighted token representations to complement the transformer embeddings. By using these specific vectorization procedures, the server obtains high-dimensional feature vectors that differentiate between semantically different texts more accurately than simple n-gram or keyword matching, thereby improving the precision and recall of similarity analysis.

For image data, the server uses an image feature extraction submodule that includes an image encoder. In one embodiment, the server employs a convolutional neural network (CNN) architecture such as a residual network or a vision transformer. The server passes the normalized image through multiple convolutional layers, activation layers, pooling layers, and optionally residual connections, and obtains an intermediate feature map. The server applies global pooling or a projection layer to the feature map to generate a fixed-dimensional feature vector. Alternatively or additionally, the server detects local keypoints in the image and computes local descriptors. The CNN-based representation provides robustness against small geometric or color variations, so that visually similar images are mapped to feature vectors that are close in the feature space, thereby reducing false negatives in similarity detection. For video data, the server uses a video analysis submodule that processes extracted frames. The server passes each key frame through the image feature extraction submodule to obtain frame-level feature vectors. The server then aggregates the frame-level vectors over time using techniques such as temporal pooling, sequence encoding, or temporal attention to produce a set of feature vectors representing the visual dynamics of the video. In an alternative embodiment, the server uses a 3D convolutional neural network or a recurrent neural network to directly process short video clips. By encoding both spatial and temporal patterns, the video feature extraction submodule can detect similarities in scene composition and motion, not merely in individual frames, thereby improving accuracy in detecting derivative or highly similar video content.

For audio data, the server uses an audio analysis submodule. The server converts the audio waveform into a time-frequency representation such as a mel-spectrogram or a chroma representation. The server applies a sliding window over the spectrogram to create short-time frames and computes features such as mel-frequency cepstral coefficients (MFCCs), chroma features, or spectral contrast for each frame. The server then aggregates the frame-level features using sequence modeling techniques such as recurrent neural networks, convolutional neural networks over time, or attention-based encoders, to generate one or more feature vectors representing melodic, harmonic, and rhythmic patterns. This representation enables the server to identify similarity between musical works even when tempo or key differs slightly, which a simple waveform comparison could not achieve efficiently.

The server stores the generated feature vectors in a vector index structure. In one embodiment, the server uses a vector database or an approximate nearest neighbor index such as an inverted file index or a graph-based index. The server also maintains an existing work database that stores feature vectors of existing copyrighted works together with identifiers and metadata. The server thereby supports efficient similarity searches in high-dimensional spaces with sub-linear time complexity. Compared with naive pairwise comparisons, the use of an approximate nearest neighbor index significantly reduces computation time and memory usage when processing large volumes of content.

The server executes a similarity calculation module that receives the feature vectors of the newly generated content and queries the existing work database. The similarity calculation module uses a vector similarity calculation algorithm such as cosine similarity for normalized vectors or Euclidean distance for unnormalized vectors. For text feature vectors, the server computes cosine similarity between the sentence embeddings. For image and video frame feature vectors, the server measures distances in the CNN feature space. For audio feature vectors, the server uses a time-axis alignment algorithm such as dynamic time warping to align sequences of features and compute a similarity score that accounts for temporal variations. The server may further normalize similarity scores across different modalities and combine them using weighted formulas. Because the similarity calculation module uses high-dimensional feature vectors and optimized similarity metrics, it can distinguish between minor incidental overlaps and substantive structural similarity, thereby reducing both false positives and false negatives relative to simple hash or string comparisons.

The server compares the similarity index values with a threshold that may be configured per content type or per client platform. The server selects those existing works whose similarity index exceeds the threshold as similarity candidates. The server additionally computes matching section information indicating which positions in the generated content correspond to those in the existing works. For text data, the server uses alignment algorithms at the sentence or token level to identify overlapping segments. For audio and video, the server uses time index information from the feature sequences to identify time intervals with strong alignment. For images and frames, the server uses region-level feature maps or gradient-based saliency methods to infer which spatial regions contribute to similarity, thereby generating bounding box or region information.

The server generates warning information data for the user. The warning information data includes at least the identifiers and descriptive information of the similarity candidates, the similarity indexes, the matching section information, and the original prompt sentence data used to generate the content. The server also generates guidance information for modifying the prompt sentence. The server uses rule-based transformations or a guidance model to propose modifications. For example, when similarity is concentrated in the style or specific motifs, the server suggests adding constraints such as “original,” “avoid resemblance to existing commercial works,” or adjusting stylistic descriptors. The server determines such guidance by applying non-conventional rules that correlate feature-level similarity patterns with prompt wording, rather than simply instructing the user to “change the content.” This correlation is based on data structures that map detected similarity types (e.g., melodic contour similarity, narrative structure similarity, compositional layout similarity) to prompt modification templates. Consequently, the server performs a technical operation that bridges low-level feature analysis and high-level input text modification, which is not feasible by manual inspection alone at scale.

The server transmits the warning information data and the guidance information to the terminal. The terminal receives the data and displays a structured user interface, for example showing: the list of similar works with similarity scores, highlighted matching sections, the original prompt sentence, and recommended prompt modifications. The user reads the information and may choose to accept suggested modifications or to manually adjust the prompt sentence. The terminal then transmits the modified prompt sentence to the generative AI model for re-generation. Because the system links prompt sentences, feature-level similarity analysis, and guidance generation, the user can converge to acceptable, less-similar content with fewer iterations. This reduces redundant content generation and repeated uploads, thereby reducing computing load on both the generative AI platform and the server, as well as reducing network traffic between the terminal and the server.

The server exposes an application programming interface (API) that external platforms can use. An external content distribution platform or an external generative artificial intelligence platform transmits generated content data, prompt sentence data, and metadata to the server via the API. The server performs the same normalization, hashing, distributed ledger recording, feature extraction, and similarity analysis as described above, and returns structured results, including the hash value, distributed ledger transaction information, similarity indexes, similarity candidates, and guidance for prompt modification. This API-based architecture avoids redundant re-implementation of complex similarity analysis and distributed ledger interaction in each external platform. Instead, the external platforms delegate these technical tasks to a specialized server optimized for them. As a result, the overall system improves computational efficiency, centralizes and standardizes similarity analysis, and reduces inconsistencies between different services.

The server improves computer technology rather than simply automating human judgment. The server applies specific normalization algorithms and multimodal feature extraction pipelines that reduce variance due to encoding and representation, thus significantly improving the reliability of hash-based integrity checks and similarity detection. The server employs high-dimensional indexing and approximate nearest neighbor search to reduce processing time for large-scale similarity comparisons. The server uses structured guidance that is automatically derived from feature-level similarity patterns to reduce the number of generation and upload cycles required to obtain acceptable content. By causally linking prompt sentence data, feature-level similarity analysis, and guidance, and by recording hashes in a distributed ledger, the server achieves improved processing speed, improved accuracy of similarity detection, improved integrity verification, and reduced communication and storage overhead in networked computing environments.

In alternative embodiments, the server uses different neural network architectures for feature extraction, such as recurrent neural networks for sequential text or audio data, autoencoder architectures for deriving compact latent codes, or graph neural networks for representing structural relationships in video scenes or document layouts. The server may also use different similarity metrics, such as Mahalanobis distance or learned similarity functions trained with contrastive loss. The server may adjust thresholds dynamically based on usage patterns, estimated risk levels, or content categories. The distributed ledger may be implemented as a permissioned or permissionless ledger. The system may support encryption of stored content and feature vectors and may enforce access control at the API level.

The terminal may be realized as a native mobile application, a desktop application, or a web application running in a browser. The server may be realized as one logical server or a distributed set of microservices, each handling different functions such as ingestion, normalization, hashing, blockchain interaction, feature extraction, indexing, similarity computation, and warning generation. The user interacts with the system through graphical user interfaces that clearly present warnings and guidance. In all embodiments, the server, the terminal, and the external platforms cooperate to implement the functions defined in the claims, and a person skilled in the art can realize the detailed implementation using the described hardware and software components without undue experimentation.

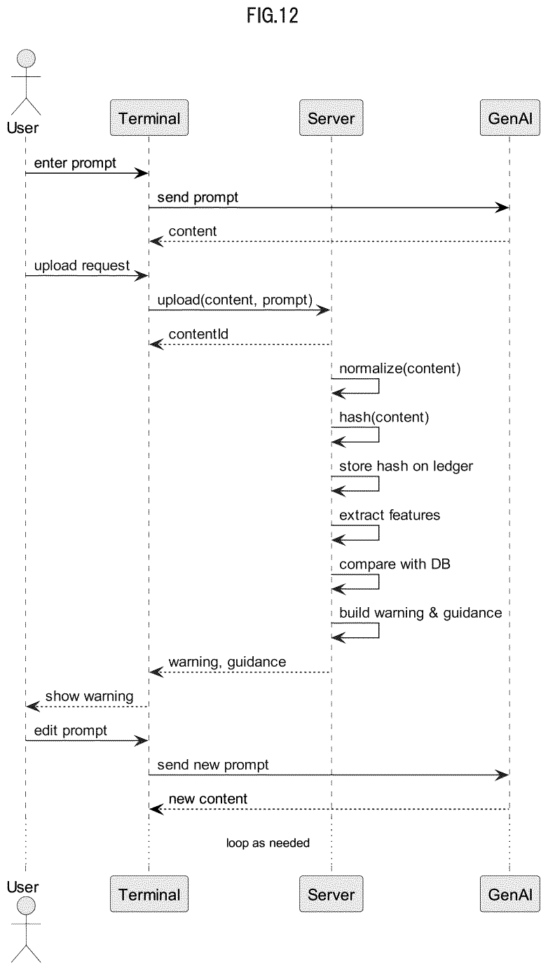

The following describes the processing flow using FIG. 12.

### Step 1: Prompt Input and Content Generation

The user operates the terminal and inputs a prompt sentence into a text input field displayed on a graphical user interface.

The terminal receives, as input, the prompt sentence text and a user identifier.

The terminal transmits the prompt sentence to a generative AI model, either running locally on the terminal or on an external generative AI platform, using a network request that includes the prompt sentence and configuration parameters such as content type (text, image, audio, or video) and target style.

The generative AI model processes the prompt sentence by converting it into token IDs, embedding the tokens, and executing neural network layers (for example, transformer blocks with attention and feed-forward layers) to compute output distributions over tokens or latent features.

Based on these computations, the generative AI model outputs, as generated content data, text strings, pixel arrays, audio waveforms, or video frame sequences.

The terminal receives, as output, the generated content data and stores it in a local file (for example, a text file, image file, audio file, or video file) together with metadata indicating the original prompt sentence and content type.

The terminal displays a preview of the generated content and presents a control element that allows the user to initiate upload to the server.

Step 2: Content Selection and Upload from Terminal to Server

The user reviews the generated content on the terminal and selects content to be checked, for example by clicking an “Upload for copyright check” button.

The terminal takes, as input, the generated content file path, the stored prompt sentence, the user identifier, and the content type.

The terminal reads the generated content file into memory as a byte sequence and constructs an HTTP request containing the byte sequence, the prompt sentence text, the user identifier, and the content type as request fields.

The terminal transmits this HTTP request to the server via a secure network connection. The server receives, as input, the HTTP request containing the generated content data, the prompt sentence data, and associated metadata.

The server parses the request, extracts the content bytes, the prompt sentence, and the metadata, and stores the content bytes into a non-volatile storage (for example, under a generated content ID path) and the prompt sentence plus metadata into a database record linked by a content identifier.

The server outputs, as a result, a content identifier that uniquely identifies the stored content and returns this identifier to the terminal in a response message.

### Step 3: Content-Type Detection and Normalization on the Server

The server receives, as input, the content identifier and associated metadata that includes a file path and a declared content type (text, image, audio, or video).

The server loads the generated content bytes from storage using the file path associated with the content identifier.

The server determines the effective content type by evaluating the metadata and, if needed, by inspecting the file header or MIME type, and outputs a resolved content type label.

The server applies, based on the resolved content type, a corresponding normalization routine:
For text, the server converts the text to a standard encoding (for example, UTF-8), normalizes line breaks, and replaces irregular whitespace or equivalent characters to obtain a canonical character sequence.
For images, the server decodes the image, converts it to a standard color space, resizes it to a canonical resolution, and optionally applies noise reduction to obtain a normalized pixel array.
For audio, the server decodes the audio stream, resamples it to a standard sampling rate and bit depth, and normalizes amplitude levels to obtain a normalized waveform.
For video, the server decodes the video, extracts key frames at fixed time intervals or scene boundaries, resizes the frames, and converts them to a standard color space to obtain a sequence of normalized frames.

The server outputs, as a result of normalization, a normalized data representation (canonical text, normalized image tensor, normalized audio waveform, or sequence of normalized video frames) together with the content identifier.

### Step 4: Hash Computation and Digital Fingerprint Generation

The server receives, as input, the normalized data representation and the content identifier. The server initializes a hash computation context using a cryptographic hash function (for example, a secure hash algorithm) and sets internal hash state variables.

The server reads the normalized data representation in fixed-size blocks (for example, blocks of several kilobytes for large files), and for each block, the server feeds the block bytes into the hash function, which performs bitwise and arithmetic operations to update the hash state. After processing all blocks, the server finalizes the hash computation and obtains a fixed-length hash value in binary form.

The server converts the binary hash value into a textual representation such as a hexadecimal string and associates this value with the content identifier.

The server stores the hash value, the hashing algorithm name, and the content identifier in a database record.

The server outputs, as a result, the hash value linked to the content identifier and marks the content as having a computed digital fingerprint.

### Step 5: Recording Hash in a Distributed Ledger

The server receives, as input, the hash value, the content identifier, and ledger configuration information.

The server constructs transaction data that includes the hash value, a reference to the content identifier, and optional metadata such as a timestamp or content type code.

The server signs the transaction data with a private key, using a cryptographic signing algorithm to generate a digital signature.

The server transmits the signed transaction to a distributed ledger node over a network protocol defined by the ledger system.

The distributed ledger node validates the transaction by checking the signature and consensus rules and appends the transaction to a block.

The server receives, as output from the ledger node, a transaction identifier, a block identifier, and a ledger timestamp.

The server stores this ledger information in the database in association with the hash value and the content identifier.

The server outputs, as a result of this step, a ledger registration status indicating that the content's digital fingerprint is recorded in a tamper-resistant distributed ledger.

### Step 6: Feature Extraction for Similarity Analysis

The server receives, as input, the normalized data representation and the resolved content type for the content identifier.

For text content, the server passes the normalized text into a natural language processing module that tokenizes the text into sub-word tokens, maps tokens to embeddings using an embedding matrix, and processes the token embeddings through a pre-trained text encoder (for example, a transformer). The server then computes a fixed-dimensional sentence or document embedding by aggregating hidden states.

For image content, the server passes the normalized image tensor into an image encoder (for example, a convolutional neural network or vision transformer), computes intermediate feature maps, and applies pooling and projection operations to derive one or more feature vectors representing the visual characteristics of the image.

For video content, the server passes each normalized key frame through the image encoder to produce frame-level feature vectors, and aggregates these vectors over time using pooling or sequence encoding to produce a set of video feature vectors.

For audio content, the server computes a time-frequency representation such as a mel-spectrogram, extracts frame-level features (for example, cepstral coefficients or chroma features), and passes them through an audio encoder (for example, a recurrent or convolutional network) to obtain an aggregated audio feature vector or sequence of vectors. For each modality, the server thereby performs numeric operations (matrix multiplications, non-linear activations, pooling) on standardized input arrays to produce feature vectors that capture semantic, visual, or auditory properties.

The server outputs, as a result, a set of feature vectors associated with the content identifier and stores these vectors in a vector index or database.

### Step 7: Similarity Calculation Against Existing Works

The server receives, as input, the set of feature vectors of the newly generated content and access to a database of feature vectors for existing copyrighted works.

The server queries a vector index structure (for example, an approximate nearest neighbor index) with the input feature vectors to retrieve candidate nearest neighbors from the existing work database.

The server computes, for each candidate existing work, a similarity index by applying a similarity metric such as cosine similarity for normalized vectors or Euclidean distance for unnormalized vectors. For sequential features such as audio or video sequences, the server performs time-axis alignment (for example, dynamic time warping) to align sequences and compute a similarity score over aligned segments.

The server compares each similarity index to one or more thresholds defined per content type or risk level.

The server selects, as similarity candidates, those existing works whose similarity index exceeds the corresponding threshold.

The server further computes matching section information by identifying positions or intervals in the generated content's feature sequences and in the existing works' feature sequences that contribute most to the similarity score.

The server outputs, as a result, a similarity result set comprising, for each similarity candidate, the existing work identifier, the similarity index, and the matching section information, all associated with the content identifier.

### Step 8: Warning and Guidance Generation

The server receives, as input, the similarity result set, the original prompt sentence data, and metadata for the generated content.

The server analyzes the similarity indices and matching section information to determine which aspects of the content (for example, specific phrases, visual motifs, or melodic patterns) are causing high similarity.

The server generates warning information that includes identifiers and descriptions of the similarity candidates, their similarity indices, and the matching sections.

The server generates guidance information for prompt modification by applying rule-based transformations or guidance models that map types of detected similarity (for example, stylistic similarity in text, compositional similarity in images, or melodic contour similarity in audio) to suggested changes in the wording of the prompt sentence. For example, for a text story with high similarity to an existing fantasy novel, the server may suggest adding phrases such as “with a unique plot and characters not resembling existing famous fantasy novels.”

The server constructs a warning information data structure that embeds the original prompt sentence, the suggested modified prompt sentences, and explanatory text describing why certain changes may reduce similarity indices.

The server outputs, as a result, the warning information data and guidance data for the content identifier.

### Step 9: Warning Display and Prompt Refinement on the Terminal

The terminal receives, as input, the warning information data and guidance data from the server, including similarity candidates, similarity indices, matching section information, and suggested prompt modifications.

The terminal parses the received data and renders a user interface that displays: (i) a warning that the generated content is similar to existing works, (ii) a list of the similar works with similarity indices, (iii) highlighted portions of the content corresponding to the matching sections (where feasible), (iv) the original prompt sentence, and (v) one or more suggested modified prompt sentences.

The user views, as output on the display, the warning and the guidance information and decides whether to modify the prompt sentence, re-generate the content, or cancel further processing.

If the user chooses to refine the prompt, the user selects or edits a suggested modified prompt sentence, such as:

“Please compose an original, royalty-free melody inspired by 1980s synth-pop, clearly different from any existing commercial tracks.” or

“Please generate the opening of an adventure story set in a medieval magical kingdom, ensuring it is original and not similar to existing famous fantasy novels.” The terminal takes, as input, the modified prompt sentence and the user's selection to re-generate content.

The terminal transmits the modified prompt sentence to the generative AI model, receives newly generated content data as output, and repeats the upload and analysis steps starting from Step 2, thereby closing an iterative loop of guided content refinement.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In recent years, generative AI models have made it possible for general users to generate large volumes of digital content, such as text, images, and video, based on prompt sentences. Conventional information processing systems that store or deliver such content generally treat the generated output as opaque data objects. These systems typically compute, at most, a simple hash value for file-level integrity checking, or perform isolated content scanning for copyright issues. As a result, multiple technical problems arise in the way computers manage, track, and control generative AI content.

First, conventional systems do not integrate, within a unified processing pipeline, (i) cryptographic identification of content, (ii) tamper-resistant recording of the identification in a distributed ledger, and (iii) automated similarity evaluation against existing information resources. In many cases, hash generation is performed as a stand-alone file operation, distributed ledger recording is not performed at all or is manually triggered, and similarity checking is implemented as a separate batch process. This fragmented architecture leads to redundant data transfers, inconsistent state between subsystems, and increased latency. From a computer-technology standpoint, such fragmentation degrades system robustness and makes it difficult for a processor to guarantee that the specific content instance evaluated for similarity is identical to the instance registered as proof of existence.

Second, conventional content-filtering or rights-management engines typically apply uniform warning messages regardless of the user's emotional state or interaction context. Computer systems that merely output fixed warning templates fail to adapt the presentation of warnings to the user's current condition. As a result, users may ignore important warnings when they are indifferent or overly excited, or may experience unnecessary stress when they are already anxious. This lack of adaptive behavior is not only a usability issue; it also represents a technical shortcoming: the processor treats user-interaction signals (imaging, audio, and operation logs) as discardable by-products rather than as structured input signals that can be processed and fused to control downstream system behavior. Thus, existing systems underutilize sensor data pathways and do not implement an integrated computational model for emotion-aware interaction.

Third, conventional architectures for copyright management around generative AI are not designed as reusable, programmatic services. Generative AI platforms often operate as isolated applications with limited or no API-level integration into external rights-management components. As a result, an external generative AI service cannot easily delegate hash generation, distributed-ledger registration, similarity evaluation, and warning generation to a dedicated server. Instead, such logic must be re-implemented or manually orchestrated across disparate systems, which increases complexity, network overhead, and the chance of inconsistency or failure. From the perspective of computer architecture, this absence of a standardized integration mechanism prevents a processor from exposing a coherent set of processing functions that can be invoked remotely in a predictable manner.

Fourth, existing systems generally do not maintain an explicit, machine-readable association between (i) the prompt sentence, (ii) the generative AI model identifier, (iii) the content hash recorded on a distributed ledger, (iv) similarity scores to existing works, and (v) user emotion states and responses. Without such an association, downstream processing such as audit logging, compliance analysis, and adaptive tuning of algorithms must rely on ad hoc correlation, which is computationally inefficient and error-prone. Conventional databases are not structured to store and query these combined relationships in real time, so processors cannot easily perform integrated analysis or generate context-aware responses. Accordingly, there is a need for an improved computer-implemented system and processing architecture that, in response to generative AI model outputs created from prompt sentences, automatically and consistently: (i) computes content-level identification information, (ii) records the identification in a distributed ledger as proof of existence, (iii) evaluates similarity to existing information resources using modality-appropriate feature extraction and comparison, (iv) estimates a user's emotional state from multimodal sensor and interaction data, and (v) generates and outputs adaptive warning information whose content and expression style are controlled based on both similarity results and the estimated emotional state. There is also a need for such processing to be exposed as an integration interface so that external generative information processing services can invoke these capabilities without replicating complex logic.

The specific processing by the specific processing unit 290 of the data processing device 12 in Example 2 is realized by the following means.

The present invention provides a server comprising a processor and a memory storing instructions that, when executed by the processor, cause the server to receive, from an information processing apparatus or an information processing service, a prompt sentence and generated information produced by a generative AI model based on the prompt sentence; to generate, by applying a hash function to content of the generated information, fixed-length identification information that uniquely identifies the generated information; to transmit the identification information as a transaction to a distributed ledger and cause the distributed ledger to record the identification information in a tamper-resistant manner; to calculate, based on the generated information and pre-stored existing information resources, similarity scores that numerically represent similarity between the generated information and each of the existing information resources by executing modality-appropriate feature extraction and comparison processing; to receive imaging data, audio data, and operation log data acquired from an imaging device, an audio acquisition device, and an operation input device, and to estimate an emotional state of a user by executing preprocessing, feature extraction, and inference processing on at least part of the imaging data, the audio data, and the operation log data so as to obtain an emotion category and an emotion intensity; to determine content and an expression style of warning information relating to a risk of copyright infringement, based on both the similarity scores and the estimated emotional state, and to output the warning information to the information processing apparatus; to provide, via a communication interface, at least part of processing functions of hash generation, distributed-ledger recording, and similarity evaluation to an external generative information processing service that generates the generated information by the generative AI model based on the prompt sentence; and to control display of an operation screen on a terminal apparatus such that the operation screen enables the user to input the prompt sentence, to view a generation result produced by the generative AI model, to initiate copyright-management processing, and to select a response policy based on the warning information, and such that the terminal apparatus transmits the generated information, the prompt sentence, and identification information of the generative AI model to the server. This enables the computer system to implement an integrated, technically improved processing pipeline in which cryptographic identification, distributed-ledger registration, similarity evaluation, multimodal emotion estimation, and adaptive warning generation are performed in a coordinated manner in response to generative AI outputs created from prompt sentences, thereby improving consistency, robustness, and responsiveness of copyright-management processing and providing a reusable interface for external generative information processing services.

The term “system” refers to a combination of one or more information processing devices including at least one processor and memory, and optionally one or more terminal apparatuses and external services, that cooperate via one or more communication networks to execute the claimed functions.

The term “server” refers to an information processing device, or a group of cooperating information processing devices, that includes at least one processor and memory and that provides services or processing functions to one or more external apparatuses or services via a communication network.

The term “processor” refers to one or more hardware processing units, such as a central processing unit, a graphics processing unit, a digital signal processor, or a combination thereof, configured to execute instructions stored in a memory.

The term “memory” refers to one or more storage media, such as a semiconductor memory, a magnetic storage device, or an optical storage device, that store instructions and data for execution by a processor.

The term “prompt sentence” refers to input information including a natural language expression or other user-provided instruction that specifies content, style, conditions, or constraints for content to be generated by a generative AI model.

The term “generative AI model” refers to a trained information processing model that, in response to input including a prompt sentence, automatically generates digital content such as text, image, audio, or video data.

The term “generated information” refers to digital content data, including text data, image data, audio data, video data, or combinations thereof, that is produced as an output of a generative AI model based on a prompt sentence.

The term “information processing apparatus” refers to an electronic device that includes a processor and memory and is configured to execute programs, perform data communication, and interact with a user, such as a personal computer, a smartphone, or a tablet device. The term “information processing service” refers to a service executed on one or more information processing apparatuses that provides processing functions via a communication network, such as a cloud-based content generation service or an application programming interface.

The term “external generative information processing service” refers to an information processing service that is separate from the claimed server and that executes a generative AI model to generate content based on a prompt sentence and to transmit the prompt sentence and the generated information to the server.

The term “identification information” refers to data having a fixed length computed from content of generated information by applying a hash function, the data being suitable for uniquely identifying the generated information and detecting alteration of the generated information.

The term “hash function” refers to a predetermined mathematical function that receives an arbitrary-length input and outputs a fixed-length value such that it is computationally infeasible to find two different inputs that produce the same output.

The term “distributed ledger” refers to a data structure maintained across multiple network nodes that stores records in an append-only, tamper-resistant manner through a consensus mechanism, including but not limited to blockchain-type ledgers.

The term “transaction” refers to a data unit submitted to a distributed ledger that requests recording of specific information, such as identification information and associated metadata, in a block or record of the distributed ledger.

The term “existing information resources” refers to digital data representing previously stored works, including textual works, image works, audio works, video works, or combinations thereof, that are used as reference data for similarity evaluation.

The term “similarity score” refers to a numerical value calculated based on feature vectors of generated information and existing information resources, the numerical value representing a degree of similarity between the generated information and each existing information resource.

The term “feature extraction” refers to processing that converts raw data, such as text, images, audio, or operation logs, into numerical representations or feature vectors that capture characteristics relevant to similarity evaluation or emotion estimation.

The term “emotion category” refers to a label representing a type of emotional state of a user, including categories such as anxiety, indifference, alertness, excitement, and neutrality, or equivalents thereof.

The term “emotion intensity” refers to a numerical value or vector indicating a strength or degree of one or more emotion categories associated with a user's emotional state.

The term “imaging data” refers to digital data representing still images or video images acquired by an imaging device, including facial images or other images that can be used for facial expression analysis.

The term “audio data” refers to digital data representing sound signals acquired by an audio acquisition device, including user speech and other audio information used for acoustic emotion analysis.

The term “operation log data” refers to digital data representing time-stamped records of user input operations, including keyboard inputs, pointing device movements, clicks, taps, and other interaction events with a terminal apparatus.

The term “emotional state” refers to information indicating a user's psychological condition, expressed as one or more emotion categories and corresponding emotion intensity values. The term “warning information” refers to output information presented to a user that includes at least one of a similarity evaluation result, a risk level or indication relating to potential copyright infringement, information about related existing information resources, and recommended actions for the user.

The term “expression style of warning information” refers to presentation attributes of warning information, including wording tone, level of emphasis, visual format, and interaction modality, which can be varied according to similarity scores and a user's emotional state.

The term “operation screen” refers to a user interface screen displayed on a terminal apparatus that enables a user to input a prompt sentence, view generated information, initiate copyright-management processing, and select a response policy based on warning information.

The term “terminal apparatus” refers to an information processing apparatus operated by a user that is configured to display an operation screen, capture imaging data, audio data, and operation log data, and communicate with the server.

The term “communication interface” refers to hardware and software components that enable data communication between the server and an external apparatus or service via a communication network, using protocols such as HTTP or other standardized communication protocols.

The term “similarity evaluation” refers to processing that calculates similarity scores between generated information and existing information resources by using feature vectors and a distance or angle metric, and that identifies existing information resources having similarity scores greater than or equal to a predetermined threshold.

The term “hash generation” refers to processing that applies a hash function to content of generated information to produce fixed-length identification information.

The term “distributed-ledger recording” refers to processing that creates and submits a transaction including identification information to a distributed ledger and verifies that the transaction has been recorded in the distributed ledger.

The term “response policy” refers to a user-selectable option indicating how the user intends to handle generated information in view of warning information, including options such as revising the generated information, regenerating the generated information with a different prompt sentence, or discontinuing use of the generated information.

In one embodiment, a server, a terminal, and a user cooperate to implement a system that performs copyright management and similarity evaluation for content generated by a generative AI model based on a prompt sentence.

### A. Hardware and Software Configuration

A server operates on general-purpose computer hardware including at least one central processing unit (CPU), optionally one or more graphics processing units (GPUs), a main memory, a nonvolatile storage device such as a solid-state drive, and a network interface. The server executes a server-class operating system such as a general-purpose server operating system and runs middleware components including a web server program, an application framework, a relational database management system, a distributed-ledger (blockchain) client, and machine-learning frameworks.

In one example, the server uses a web server program to accept Hypertext Transfer Protocol (HTTP) requests, uses an application framework such as a script language runtime or virtual machine framework to implement application logic, uses a relational database management system such as a general-purpose relational database engine to store metadata, uses a blockchain client library compatible with a permissioned or public blockchain platform, and uses a machine-learning framework such as a neural network library to implement similarity models and emotion-recognition models.

A terminal operates on client hardware such as a personal computer, a tablet device, or a smartphone. The terminal includes at least one CPU, a memory, a display, a camera as an imaging device, a microphone as an audio acquisition device, and input devices such as a keyboard, a pointing device, or a touch panel. The terminal executes a client operating system such as a general-purpose desktop or mobile operating system. The terminal runs either a web browser, which executes scripts and renders hypertext content, or a dedicated native client application. The terminal may use a web application framework, for example a component-based JavaScript framework, to control the user interface.

The server connects to one or more external generative information processing services via a communication network such as the Internet. An external service executes a generative AI model on its own hardware and provides an application programming interface to generate content based on a prompt sentence.

### B. Configuration of the Generative AI Model and Example Prompt Sentences

In one embodiment, the external generative information processing service provides a generative AI model that is a neural network trained to generate text, images, or video. For text generation, the generative AI model may be a transformer-based language model composed of multiple self-attention layers, feedforward layers, and layer-normalization layers. The model may be trained on a large corpus of text using an auto-regressive objective with cross-entropy loss and optimized with gradient-based methods such as Adam. For image generation, the generative AI model may be a diffusion-based model or a generative adversarial network having a convolutional encoder-decoder architecture, trained on large-scale image datasets. For video generation, the model may extend the image architecture by temporal convolution or attention layers to handle sequences of frames.

User provides a prompt sentence to the generative AI model via the terminal. Example prompt sentences include:

“Please generate the opening of an adventure story set in a medieval magical kingdom, in about 1,000 characters.”

“Please draw an impressionist-style landscape painting.”

“Please create a short video set in a futuristic city.”

“Please generate a scene breakdown for a roughly 2-minute short cyberpunk-style video set in near-future Tokyo.”

The external service receives the prompt sentence, executes forward propagation on the generative AI model using the prompt sentence as input, and generates corresponding text, image, or video content. The external service then returns the generated information and associated metadata, such as a model identifier and a generation time, to the terminal.

C. Data structures and processing in the server

Server stores and processes several categories of data. Server uses specific data structures in the relational database to support technical effects such as integrity of associations among items and efficient queries.

Server maintains a content table that stores, for each generated content instance, at least a content identifier, a content hash value, a prompt sentence, a generative AI model identifier, a user identifier, a creation timestamp, a registration timestamp, and references to one or more files storing the generated information. The content hash value is a fixed-length binary value or encoded string computed using a cryptographic hash function such as SHA-256 on the raw byte sequence of the generated content file.

Server maintains a ledger table that associates the content hash value with distributed-ledger metadata such as a ledger transaction identifier, a block index, and a ledger timestamp. This table enables server to verify that the content hash was actually recorded on the distributed ledger and to retrieve the ledger record efficiently.

Server maintains an existing-work table that stores existing information resources used as references for similarity evaluation. For each existing work, server stores an identifier, a content type (text, image, video), a storage location, and one or more precomputed feature vectors. For text, server may store a TF-IDF vector and a dense embedding vector. For images, server may store a feature vector obtained from an intermediate layer of a convolutional neural network. For videos, server may store feature vectors of key frames and an aggregated feature vector.

Server maintains an emotion table that stores, for each content instance and user, an emotion state, which includes an emotion category label and an emotion intensity vector. The emotion intensity vector is a numeric vector, for example a floating-point array, whose elements correspond to probabilities or normalized scores for classes such as anxiety, indifference, alertness, excitement, and neutrality.

Server maintains a similarity-result table that stores, for each content instance, similarity scores to multiple existing works. Each record may include a content identifier, an existing work identifier, a similarity score, and possibly a rank index. These stored scores enable server to generate warnings rapidly without recomputing similarities when a user later revisits the same content.

Server maintains a user-action table that records the user's response policy, for example “revise content,” “regenerate with different prompt,” or “discontinue use,” along with timestamps and identifiers. This table can be used by the server to perform later analysis, such as refining thresholds or rules using logged behavior.

### D. Emotion Estimation Processing

Server executes concrete machine-learning models for emotion estimation. Server uses a modular architecture to handle imaging data, audio data, and operation log data separately and then fuse the results.

Server uses an image emotion-recognition model that is, for example, a convolutional neural network such as a residual network. Server applies a face-detection algorithm, such as a cascade classifier or a deep neural network detector, to imaging data that contains a user's face. Server extracts a face region and normalizes it by resizing to a fixed resolution (for example, 224×224 pixels) and scaling pixel values to a fixed numeric range. Server feeds the normalized face images into the convolutional neural network, which outputs a probability distribution over emotion categories. The convolutional network may have a series of convolutional layers, non-linear activation functions such as ReLU, pooling layers, and fully connected layers. During training, the network is optimized using supervised learning on labeled facial-expression datasets, minimizing a cross-entropy loss with respect to the ground-truth emotion labels.

Server uses an audio emotion-recognition model that processes the audio data. Server extracts acoustic features such as Mel-frequency cepstral coefficients, pitch contours, energy, and spectral flux using a digital signal processing library. Server packs these features into a feature matrix over time. Server feeds the feature matrix into a neural network, such as a recurrent neural network or a temporal convolutional network, which outputs emotion probabilities. The network is trained on labeled speech emotion datasets, possibly with data augmentation techniques such as time-stretching, pitch-shifting, and noise injection to improve robustness.

Server uses a behavior-recognition model for operation log data. Server computes features such as distributions of inter-key intervals, frequency of rapid sequences of mouse movements, and variability of cursor paths. Server constructs a feature vector possibly including time-windowed statistics and histograms of input events. Server feeds this feature vector into a classifier, which may be a gradient-boosted decision tree model or a shallow neural network, to estimate stress or confusion levels.

Server then uses a fusion model or rule set to combine the three modality-specific outputs. For example, server may implement a small fully connected neural network that takes as input the concatenation of the facial emotion probabilities, speech emotion probabilities, and behavior-derived stress scores. The fusion network outputs a final emotion category and a vector of intensity scores. The fusion network can be trained to minimize a loss function defined over labeled multimodal data. Alternatively, server may use a rule-based system that assigns weighted importance factors to each modality and computes a weighted sum to derive a final score.

Because server uses these multimodal, feature-based models, the server achieves more accurate and robust emotion estimation than simple threshold-based heuristics. This improved emotion estimation enables server to adjust the warning expression style optimally, thus increasing the likelihood that the user notices a high-risk warning and reducing unnecessary anxiety in low-risk cases. This processing is not a mere automation of human judgment because the fusion of multiple sensor modalities and learned nonlinear combinations of features are not naturally performed by human operators in real time.

### E. Similarity Evaluation Processing

Server executes concrete algorithms for similarity evaluation of generated information against existing information resources.

For text content, server uses a natural-language processing library to perform tokenization and normalization. Server computes, for each text, a TF-IDF vector using a vocabulary built from the corpus of existing works and optionally from past generated texts. Server also computes a dense semantic embedding using a trained language representation model such as a transformer encoder that maps a sequence of tokens into a fixed-length vector, for example by average pooling of token embeddings or by using a dedicated classification token output. The transformer encoder, during training, may be optimized by masked language modeling or contrastive learning directories, using a large general corpus.

Server compares the generated text vector and each existing work vector using cosine similarity or dot product operations. Server may combine TF-IDF similarity and semantic embedding similarity by weighted addition or other fusion methods to improve robustness against lexical variation and paraphrasing. Because these feature vectors are stored in the database, server can compute similarities by vector operations in main memory, reducing disk I/O and computation time compared to reprocessing the raw text for each query. For image content, server uses an image-processing library to resize images and normalize them. Server then feeds images into a feature extractor based on a convolutional neural network trained for recognition tasks. Server uses the activation values of an intermediate layer, flattened into a feature vector, as a representation of the image's content. Alternatively, server may use local feature descriptors and bag-of-visual-words models. Server compares the generated image's feature vector with precomputed feature vectors of existing image works using a similarity metric such as Euclidean distance or cosine similarity. By using the same feature space for all images, server can use efficient nearest-neighbor search methods or approximate search structures, such as locality-sensitive hashing, to accelerate similarity retrieval.

For video content, server uses a video decoding library to extract key frames at predetermined intervals or based on motion change metrics. Server generates image feature vectors for each key frame as described above. Server then aggregates frame-level similarities into an overall similarity score for each existing video work, for example by computing an average or maximum of frame similarities. The combination of frame-level feature vectors and aggregated scores enables server to account for temporal variations in videos while still performing efficient computations.

These feature-based similarity evaluations provide a technical improvement over simple hash-based or metadata-based comparison. Because server uses learned feature representations, the server can detect conceptual similarities even when the exact content is not bitwise identical, and can do so using precomputed vectors and efficient vector arithmetic operations that are well-suited to parallelization.

### F. Hash Generation and Distributed-Ledger Recording

Server computes a cryptographic hash of the generated content and records it in a distributed ledger. Server uses a streaming hash computation algorithm, which reads content data in fixed-size blocks and updates the hash state incrementally. By streaming the file instead of reading it into memory as a whole, server can process large media files without exhausting memory resources.

Server then constructs a transaction payload including the hash, timestamp, and optionally an internal content identifier. Server uses a blockchain client library to sign the transaction with a cryptographic key and to transmit the transaction to one or more ledger nodes. Server employs a consensus protocol, such as proof-of-authority or another consensus mechanism, provided by the underlying ledger system, to ensure that the transaction is immutably recorded once confirmed. Server stores the resulting transaction identifier and block index in the ledger table.

This mechanism provides a technical effect in that the server ensures verifiable linkage between the specific generated content instance and the ledger record, enabling later integrity checks that can be executed automatically by computing the hash of stored content and comparing it to the recorded value on the ledger. This improves reliability and trustworthiness of the system beyond simple local database logging.

### G. Warning Generation and Adaptive Expression

Server generates warning information based on similarity scores and the estimated emotion state. Server uses a rule engine or a trained classifier to determine a warning level and tone. For example, server may implement a decision tree that takes as input: (i) the maximum similarity score among all existing works, (ii) the number of works exceeding a threshold, and (iii) the intensity of specific emotions such as indifference or anxiety. The decision tree outputs a discrete warning level, such as “high,” “medium,” or “low,” and a tone category such as “strict” or “reassuring.”

Server uses template-based generation for warning messages. Server stores message templates with placeholders for variables such as work titles, similarity scores, and recommended actions. Server fills these placeholders using actual values from the similarity-result table and context such as the emotion category. For example, when the similarity is high and the user is indifferent, server selects a template with explicit and strongly worded phrases. When the similarity is moderate and the user is anxious, server selects a template with softer phrasing and additional guidance on corrective actions.

Server may optionally invoke a text generation model to refine grammar and naturalness of the warning messages, but still constrains the possible output by providing structured templates and fixed legal phrases. This hybrid approach ensures that warnings are both readable and compliant with regulatory wording, while reducing the manual effort to craft all possible combinations of contexts.

Because the server's warning generator uses structured features and learned emotion signals, the server can calibrate the warnings in ways that are not trivially achievable by static policy rules. This adaptation can increase user engagement with important warnings and reduce unnecessary distractions, thereby improving effectiveness of the warning mechanism.

### H. Interaction and Data Flow Between Server and Terminal

Terminal provides an operation screen that allows user to input a prompt sentence, display generated content, initiate copyright-management operations, and view the resulting warnings. Terminal uses a structured layout with dedicated components for input, content display, control buttons, and warning display. Terminal executes script code or native UI logic to perform local input processing, such as trimming whitespace from the prompt sentence, validating input length, and converting generated content into appropriate file types. Terminal communicates with the server using standardized network protocols. For example, terminal sends requests with the prompt sentence, content files, and metadata using HTTP POST in multipart or JavaScript Object Notation format. Terminal also sends sensor data and operation logs to the server for emotion estimation. Terminal receives responses in structured formats and updates the displayed UI accordingly.

User interacts directly with the terminal, not the server. User types, reads, and selects options via the terminal's user interface. The technical improvements, such as efficient similarity computation and adaptive warning expression, are implemented inside the server and are not merely a reflection of predetermined business rules. The server performs nontrivial data processing such as cryptographic hashing, vector-space similarity, multimodal neural network inference, and distributed-ledger communication.

### I. Technical Effects and Computer-Technology Improvement

The described system improves computer technology in several ways.

Server reduces redundant data movement by computing a content hash, recording it in a distributed ledger, and performing similarity evaluation in a single integrated pipeline triggered by a single user action. This integration reduces the number of times the same content needs to be read from storage or transmitted between components. As a result, the system reduces overall I/O load and improves throughput.

Server improves accuracy of similarity evaluation by using learned feature vectors tailored to each content type and by combining multiple similarity measures. This leads to more reliable detection of potentially infringing content than simple string matching or hash comparison. Because these feature vectors are precomputed and stored, server can process queries using optimized numeric vector operations, which are well-suited to parallel processing on CPU or GPU, thus improving processing speed.

Server improves the management of user interaction by converting imaging data, audio data, and operation log data into structured features and combining them in a neural network fusion model. This processing yields an accurate and responsive estimation of user emotion in real time. The server then uses this estimation to control warning message characteristics, which directly affects how users interact with the system. This is qualitatively different from human operators manually deciding how strongly to warn each user, and uses data structures and algorithms that are not replicable at scale by human processes.

Server exposes an application programming interface that enables external generative information processing services to offload hash generation, ledger registration, and similarity evaluation. This standardization and centralization reduces duplicated implementations of complex algorithms across multiple services, and concentrates optimization efforts in a single, improved subsystem. External services can simply invoke the server through network calls, reducing overall maintenance effort and potential inconsistencies.

### J. Alternative Embodiments and Variations

Server may use alternative neural network architectures and algorithms. For example, server may implement a vision transformer instead of a convolutional network for emotion recognition in facial images. Server may use a transformer-based audio model that directly consumes waveform samples, thus reducing the need for handcrafted acoustic features. Server may use different distance metrics or indexing structures for similarity search, such as inner-product search with vector quantization to further speed up similarity evaluation. Server may also maintain dimensionality-reduced vectors using principal component analysis to reduce computational load while maintaining acceptable similarity accuracy.

Server may use different distributed-ledger technologies, such as a permissioned blockchain network or a public blockchain network, depending on trust and performance requirements. Server may batch multiple content-hash transactions into a single ledger transaction to reduce network overhead and transaction fees.

Terminal may be implemented as a native mobile application that uses platform-specific APIs for camera, microphone, and touch input, or as a web application that uses browser APIs. Terminal may compress images or downsample audio before sending them to the server to reduce bandwidth usage.

User may interact with the system through various user interfaces, including voice input for the prompt sentence or specialized editor components for complex content types. Regardless of user interface variations, the technical core of the system remains in the server's integrated processing pipeline combining content identification, distributed-ledger recording, similarity evaluation, multimodal emotion estimation, and adaptive warning generation.

By implementing the above components and algorithms, the server, terminal, and user collectively realize a system that supports concrete, technically grounded copyright management for content generated by a generative AI model from a prompt sentence, with improved efficiency, precision, and robustness compared to conventional architectures.

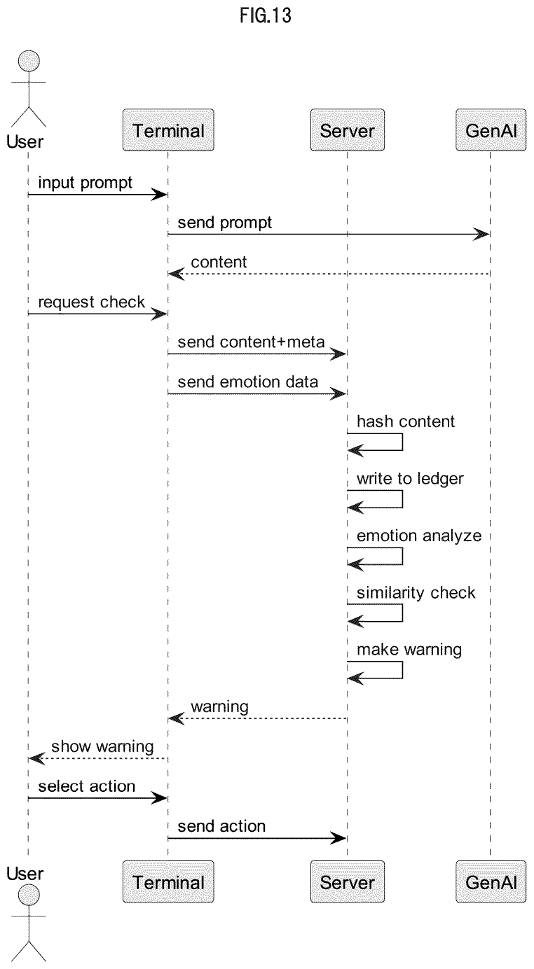

The following describes the processing flow using FIG. 13.

### Step 1:

User provides a prompt sentence to the terminal.

User inputs, as input data, a prompt sentence such as “Please generate the opening of an adventure story set in a medieval magical kingdom, in about 1,000 characters.” into a text input field displayed on the terminal. User may alternatively input other prompt sentences such as “Please draw an impressionist-style landscape painting.” or “Please create a short video set in a futuristic city.”

Terminal receives the prompt sentence as input from the text field via a user interface event. Terminal performs data processing on the input by trimming leading and trailing whitespace, normalizing line breaks, and checking that the text length is within a predefined limit. Terminal outputs, as output data, a cleaned prompt sentence stored in terminal memory and ready to be transmitted to an external generative information processing service.

### Step 2:

Terminal requests content generation from an external generative information processing service.

Terminal takes, as input, the cleaned prompt sentence and a selected generative AI model identifier stored in its state. Terminal performs data processing by constructing a structured request object including the prompt sentence, the model identifier, and generation parameters such as maximum token length, temperature, image size, or video duration. Terminal converts the structured request into a serialized message using a data format such as JSON.

Terminal outputs, as output data, an HTTP or equivalent network request message that is transmitted over a communication interface to the external generative information processing service.

### Step 3:

Server (external generative information processing service) generates content using a generative AI model.

Server receives, as input, the request message containing the prompt sentence, the model identifier, and the generation parameters. Server parses the serialized data, extracting the prompt sentence and parameters. Server performs data computation by executing forward inference on a generative AI model corresponding to the model identifier. For example, for text, server feeds tokenized representations of the prompt sentence into a transformer-based language model; for images, server feeds a text embedding into a diffusion-based image generator; for video, server feeds sequence-level conditioning inputs into a temporal generative model.

Server decodes the model's internal outputs (token IDs, image tensors, or frame tensors) into usable content data such as UTF-8 text, encoded image data, or encoded video data. Server outputs, as output data, a response message that includes the generated content data and metadata such as the model identifier and a generation timestamp, and transmits this message back to the terminal.

### Step 4:

Terminal receives and displays the generated information.

Terminal receives, as input, the response message from the external service. Terminal parses the message to extract the content data, the content type (text, image, or video), and associated metadata. Terminal performs data processing by converting the content data into internal UI objects: for text, a string assigned to a text view; for images, a decoded image object bound to an image display component; for video, a media source linked to a video playback component.

Terminal outputs, as output data, a rendered display on the terminal screen showing the generated text, image, or video and internally stored content structures used later for copyright checking.

### Step 5:

User initiates copyright-management processing for the generated information.

User views, as input, the displayed generated content on the terminal and decides that copyright management is required. User performs a specific operation such as clicking a “Copyright Check” button presented on the operation screen.

Terminal receives this operation event as input and performs data processing by retrieving the currently displayed content from its internal structures and converting it into a standardized file format: for text, a text file encoded in UTF-8; for an image, an image file such as PNG or JPEG; for a video, a video file such as MP4. Terminal outputs, as output data, a generated content file object stored in terminal memory or temporary storage, associated with the prompt sentence and the generative AI model identifier.

### Step 6:

Terminal sends the generated information and metadata to the server for registration and analysis.

Terminal receives, as input, the generated content file, the prompt sentence, the generative AI model identifier, and user/session identifiers. Terminal performs data processing by constructing a multipart or equivalent request structure that includes a binary part for the content file and text parts for the prompt sentence, the model identifier, and user-related fields. Terminal encodes the structure according to the selected network protocol. Terminal outputs, as output data, a copyright-check request message containing the generated content and metadata, and transmits this message to the server over a network. Step 7:

Terminal collects emotion-related sensor and interaction data.

Terminal takes, as input, user consent and access permissions for camera, microphone, and input logging. Terminal performs data acquisition by activating the camera to capture video frames of the user's face, activating the microphone to record audio segments of the user's speech or ambient reactions, and logging user operations such as key presses, mouse movements, and touch events with time stamps.

Terminal performs data processing by sampling video frames at defined intervals, compressing frames into image data, extracting audio segments of a fixed length, and computing summary statistics of operation logs such as average typing speed, variance of intervals, and pointer movement distance. Terminal outputs, as output data, structured imaging data, audio data, and operation log data, which are transmitted in one or more request messages to the server for emotion estimation.

### Step 8:

Server receives the generated content and computes a content hash value.

Server receives, as input, the copyright-check request containing the content file and metadata. Server parses the request, extracting the content file, the prompt sentence, the model identifier, and the user identifier. Server stores the content file in a temporary storage location and retrieves a file path or file handle.

Server performs data computation by applying a cryptographic hash function to the content file. Server reads the file in fixed-size byte blocks, updates the internal state of a hash function implementation, and after processing the entire file, obtains a fixed-length hash value that uniquely identifies the content's byte sequence. Server outputs, as output data, the hash value and a new database record that associates the hash value with the prompt sentence, the model identifier, the user identifier, and timestamps.

### Step 9:

Server records the hash value in a distributed ledger.

Server receives, as input, the hash value and associated metadata from the database record. Server performs data processing by constructing a transaction payload that embeds the hash value and a time stamp. Server serializes the payload using the format required by a distributed-ledger system and digitally signs the transaction using stored cryptographic credentials.

Server transmits the serialized transaction as output to ledger nodes over a network and waits for confirmation. After the transaction is recorded in a block, server receives, as input, a transaction identifier and a block index. Server then updates the ledger table in the database, outputting, as output data, a completed ledger record that links the content hash to a verifiable distributed-ledger entry.

### Step 10:

Server receives and preprocesses imaging, audio, and operation log data for emotion estimation.

Server receives, as input, the imaging data, audio data, and operation log data from the terminal. Server performs data processing on the imaging data by decoding image formats and applying a face-detection algorithm to locate faces in each image. Server crops face regions, rescales them to a fixed resolution, and normalizes pixel values.

Server processes the audio data by decoding the audio stream, resampling it to a standard sampling rate, and extracting acoustic features such as Mel-frequency cepstral coefficients, energy, and pitch over short time windows. Server processes the operation log data by reconstructing time series of events and calculating features such as distributions of inter-event intervals, acceleration of cursor movement, and frequency of rapid action patterns.

Server outputs, as output data, three sets of numerical feature vectors representing visual, acoustic, and behavioral characteristics of the user.

### Step 11:

Server estimates the user's emotion state using machine-learning models.

Server receives, as input, the visual, acoustic, and behavioral feature vectors. Server performs data computation by feeding the visual feature vectors into a trained convolutional neural network, feeding the acoustic feature vectors into a trained temporal neural network, and feeding the behavioral feature vector into a classifier model. Each model outputs, as intermediate output, a probability distribution or score vector over emotion categories. Server then performs fusion processing by concatenating the three score vectors and feeding the concatenated vector into a fusion model or applying a rule-based combination algorithm. This fusion step computes a final emotion category label and an emotion intensity vector. Server outputs, as output data, an estimated emotion state that is stored in the emotion table and associated with the content hash and user identifier.

### Step 12:

Server performs similarity evaluation between the generated information and existing information resources.

Server receives, as input, the generated content file and a list of existing information resources with precomputed feature vectors from the existing-work table. Server performs type-specific data processing. For text content, server tokenizes the text, normalizes tokens, computes TF-IDF vectors, and derives semantic embeddings using a language encoder. For image content, server normalizes the image and extracts a feature vector from an intermediate layer of a convolutional network. For video content, server extracts key frames and computes image feature vectors for those frames, aggregating them into a single representation.

Server then performs data computation by calculating, for each existing work, similarity scores based on a distance metric or angle metric between the feature vector of the generated content and the feature vector of the existing work. Server may calculate cosine similarity, Euclidean distance inversely mapped to similarity, or a composite score that combines multiple metrics. Server outputs, as output data, a list of existing works with associated similarity scores, and stores this list in the similarity-result table.

### Step 13:

Server generates warning information by combining similarity results and the emotion state. Server receives, as input, the similarity-result list and the estimated emotion state. Server performs decision processing by applying predefined rules or a trained decision model. For example, server compares the maximum similarity score to one or more thresholds and examines the emotion intensity values to determine whether the user is more likely to be indifferent, anxious, or in another state.

Server computes, as data processing, a warning level (such as high, medium, or low) and selects a message tone (such as strict, neutral, or reassuring) based on this analysis. Server then fills message templates with concrete data including titles or identifiers of similar existing works, similarity scores, and recommended user actions such as revision, regeneration with a different prompt sentence, or discontinuation of use. Server outputs, as output data, structured warning information containing the warning message text, warning level, expression style parameters, and supporting details.

### Step 14:

Server sends warning information to the terminal.

Server receives, as input, the structured warning information object. Server performs data processing by encoding the warning information into a serialization format such as JSON and packaging it into an HTTP response message.

Server outputs, as output data, the response message, which is transmitted over a communication interface to the terminal.

### Step 15:

Terminal displays adaptive warning information to the user.

Terminal receives, as input, the response message containing the warning information. Terminal parses the serialized data and extracts the warning message text, warning level, expression style parameters, and details of similar existing works and similarity scores.

Terminal performs data processing by selecting user interface components appropriate for the warning level, such as a modal dialog for high severity or an inline notification for low severity, and by applying visual styles (colors, fonts, layouts) based on the expression style parameters.

Terminal outputs, as output data, a rendered warning display on the terminal screen that presents the warning message, similarity details, and response options for the user to choose. Step 16:

User selects a response policy based on the warning information.

User views, as input, the warning display on the terminal and reads the message, similarity details, and recommended actions. User then performs a specific selection operation, such as clicking a button labeled “Revise content,” “Regenerate with another prompt sentence,” or “Stop using this content.”

Terminal receives the selected option as input and performs data processing by constructing a response-policy record that includes the content identifier or hash, the chosen action, timestamp, and user identifier. Terminal outputs, as output data, a log message containing this record, and transmits it to the server.

### Step 17:

Server records the user's response policy and optionally adjusts system parameters. Server receives, as input, the log message from the terminal. Server parses the message to extract the content identifier, user identifier, chosen action, and timestamp. Server performs data processing by inserting a new record into the user-action table, associating the user's response policy with the content instance and stored warning information.

Server outputs, as output data, an updated database state that can later be analyzed to refine decision thresholds, similarity rules, or emotion-weighting parameters. This stored data supports future technical improvements to processing accuracy and efficiency.

### Step 18:

Server provides processing functions to an external generative information processing service via an API.

Server receives, as input, API calls from an external generative information processing service that include a prompt sentence, generated information, and possibly user identifiers. Server performs data processing by applying the same hash generation, distributed-ledger recording, similarity evaluation, and optionally emotion-aware warning generation as described in the previous steps, but invoked programmatically through the API. Server outputs, as output data, structured responses to the external service that include content hash values, ledger transaction identifiers, similarity scores, and warning information. The external service may use these outputs to enhance its own operations without implementing the underlying algorithms, thereby leveraging the server's integrated processing pipeline.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In recent years, generative AI models have enabled rapid creation of digital content such as text, images, audio, and video based on a prompt sentence. Conventional content management systems and copyright-support tools, however, are not architected to handle the specific technical properties and risks introduced by generative AI workflows. First, known hash-based registration mechanisms typically compute a hash directly on a raw file without type-specific normalization, which results in unstable digital fingerprints that are sensitive to minor, format-level variations (for example, line-ending changes, image re-encoding noise, or insignificant audio processing). This instability makes it technically difficult for computer systems to reliably prove existence and attribution of generative content at scale, and limits the usefulness of cryptographic hashes recorded on a distributed ledger.

Second, conventional similarity-checking engines often run as siloed, batch-oriented processes that are loosely coupled, or not coupled at all, with real-time generative AI pipelines. These engines are generally optimized either for text or for a single media type, and they do not provide a unified, type-adaptive similarity evaluation across text, image, video, and music content. As a result, a server that processes generative AI output must orchestrate multiple heterogeneous subsystems, incurring high latency, increased resource consumption, and inconsistent similarity thresholds, which degrades the technical quality of copyright-risk assessment and makes it hard to integrate into interactive user interfaces.

Third, conventional systems that present copyright warnings or risk indicators typically deliver static, one-size-fits-all messages. These systems do not take into account multimodal user state signals such as facial images, voice tone, free-text feedback, or interaction logs. As a consequence, warning dialogs may be overly verbose or overly terse for a given user state, causing frustration, disengagement, or abandonment of the platform. From a computing standpoint, the lack of an emotion-adaptive control layer results in suboptimal utilization of generative AI capabilities, since users receive no technically informed guidance about how to modify prompt sentences or regenerate content to reduce similarity.

Fourth, traditional content moderation and advisory systems do not automatically transform a user's original prompt sentence into a new, technically safer prompt that is specifically optimized to reduce similarity with identified existing works. Even where generative AI is available, such systems usually rely on manual trial-and-error by the user, which leads to repeated calls to generative models, redundant computation, and inefficient use of processing resources in the server. There is no integrated mechanism that programmatically uses similarity evaluation results as structured input to a generative AI model in order to produce recommended prompt sentences that are likely to generate content with lower similarity.

Accordingly, there is a need for an improved computer-implemented system that: (i) generates stable, content-type-aware hash values for generative AI outputs and reliably records them in a distributed ledger; (ii) performs unified, type-adaptive similarity evaluation across multiple media types in an integrated server pipeline; (iii) estimates a user's emotional state from multimodal input and dynamically adjusts warning content, detail level, and user interface format; and (iv) automatically generates recommended prompt sentences using a generative AI model on the basis of similarity results and the original prompt sentence. Such a system should improve the functioning of the server itself by structuring data flows, reducing redundant processing, and enabling technically efficient and user-adaptive control of generative AI operations, rather than merely automating a human mental process.

The specific processing by the specific processing unit 290 of the data processing device 12 in Application Example 2 is realized by the following means.

The present invention provides a server comprising a processor configured to receive, from a user terminal, a prompt sentence and generated content created by a generative AI model on a basis of the prompt sentence, perform, for the generated content, normalization processing or feature extraction processing according to a content type of the generated content and apply a hash function to a data sequence obtained by the processing to generate a hash value as digital identification information of the generated content, record, in a distributed ledger, the hash value and identification information related to the generated content as transaction information in an appendable and tamper-resistant format, extract, from the generated content or from a preprocessing result of the generated content, a feature according to the content type and calculate a similarity index between the feature of the generated content and a feature previously stored for an existing work to evaluate similarity between the generated content and the existing work, acquire, from the user terminal, at least part of facial image data, audio data, text input data, or operation log data as multimodal user information and estimate an emotional state of a user by using a machine learning model or a rule-based model on a basis of the multimodal user information to generate emotion information indicating an emotion category or an emotion intensity of the user, determine, on a basis of the similarity index and the emotion information, warning content, a presentation detail level, and a user interface presentation format relating to a copyright infringement risk and generate warning information to be transmitted to the user terminal in accordance with the determined warning content, presentation detail level, and user interface presentation format, generate, on a basis of a similarity evaluation result included in the warning information and an original prompt sentence, an internal prompt for the generative AI model and cause the generative AI model to automatically generate a recommended prompt sentence that rewrites the original prompt sentence so as to reduce similarity to the existing work, and provide a communication interface that, in response to a request from an external information processing apparatus, calls at least part of hash generation, ledger recording, similarity evaluation, emotion estimation, warning generation, or prompt support functions and transmits and receives processing results with the external information processing apparatus. This enables an improved computer-implemented workflow in which the server generates stable, type-aware hash values for generative AI content, securely anchors those values on a distributed ledger, executes integrated and media-adaptive similarity evaluation, dynamically adapts warning generation to a detected user emotional state, and programmatically synthesizes revised prompt sentences via a generative AI model so as to reduce similarity to existing works, thereby improving the technical performance, reliability, and efficiency of generative AI content management and copyright-risk control.

The term “generative AI model” refers to a machine learning model, typically implemented by a deep learning architecture, that receives an input including a prompt sentence or other conditioning information and generates digital content such as text, image, audio, or video data on the basis of the input.

The term “prompt sentence” refers to a character string or sequence of symbols provided by a user, which specifies desired content, style, conditions, or constraints, and which is supplied as conditioning input to a generative AI model to cause the generative AI model to generate corresponding content.

The term “generated content” refers to digital data, including at least one of text data, image data, audio data, music data, or video data, that is produced by a generative AI model in response to a prompt sentence or other conditioning input.

The term “user terminal” refers to an information processing apparatus operated by a user, including at least one of a portable terminal, a mobile communication terminal, a smart device, or a personal computing device, that is configured to transmit a prompt sentence and associated data to a server and to present generated content, warnings, and recommended prompt sentences to the user.

The term “processor” refers to a hardware computing resource, including at least one central processing unit or processing core, and optionally an accelerator such as a graphics processing unit, that executes program instructions to perform the functions of receiving data, processing data, controlling communication, and generating output as described in the claims.

The term “hash function” refers to a one-way mathematical transformation that receives a data sequence as input and produces a fixed-length or predetermined-format value, such that it is computationally infeasible to derive the input from the output or to find two different inputs that produce the same output, and that is used to generate digital identification information for content.

The term “hash value” refers to digital identification information generated by applying a hash function to a data sequence derived from generated content, the hash value being used to uniquely or quasi-uniquely represent the content and to detect modification of the content. The term “digital identification information” refers to encoded data, including at least a hash value, that is derived from generated content and that serves as a compact, machine-processable representation for uniquely or quasi-uniquely identifying the generated content.

The term “normalization processing” refers to a transformation applied to generated content that converts the content into a canonical form according to its content type, including at least one of unifying character codes and whitespace for text, unifying resolution and color space for images, selecting and standardizing frames for video, or extracting and serializing acoustic features for audio or music, in order to stabilize downstream hashing and similarity processing.

The term “feature extraction processing” refers to computation that derives numerical descriptors or feature vectors from generated content or from normalized content, where the descriptors capture semantic or structural characteristics of the content and are used for similarity evaluation or classification.

The term “content type” refers to a classification of generated content into at least one category such as text content, image content, video content, audio content, or music content, and is used to select corresponding normalization, feature extraction, and similarity evaluation procedures.

The term “distributed ledger” refers to a logically unified recording medium, implemented by distributed ledger technology across a plurality of computing nodes, that stores transaction information in an append-only and tamper-resistant manner by using cryptographic mechanisms and consensus mechanisms.

The term “transaction information” refers to a structured data record stored in a distributed ledger, including at least a hash value derived from generated content and identification information related to the generated content, and optionally a timestamp, a user identifier, or a content identifier.

The term “existence-proof information” refers to data, including at least a hash value and associated transaction information recorded in a distributed ledger, that can be used to demonstrate that particular generated content existed at or before a recorded time and is attributable to specific identification information such as a user identifier.

The term “feature” refers to a numerical representation, such as a feature vector, a feature sequence, or a set of feature descriptors, that is extracted from content and that characterizes the content in a manner suitable for similarity evaluation or classification.

The term “similarity index” refers to a quantitative metric, such as a similarity score or a distance value, that is computed between a feature of generated content and a feature of an existing work, and that indicates a degree of resemblance between the content and the existing work.

The term “existing work” refers to pre-registered content data, including at least one of text, image, audio, music, or video data, that is stored in a storage apparatus together with feature information and metadata and that serves as a reference for similarity evaluation with respect to generated content.

The term “multimodal user information” refers to input data acquired from a user terminal and representing different sensing modalities, including at least one of facial image data, audio data, text input data, and operation log data, and that is used to estimate an emotional state of a user.

The term “emotion information” refers to data representing an estimated emotional state of a user, the data including at least one of an emotion category, such as joy, anger, sadness, anxiety, or discouragement, and an emotion intensity or confidence level associated with the category.

The term “machine learning model” refers to a trained computational model, such as a neural network, a support vector machine, or another learned classifier or regressor, that maps input data including content features or multimodal user information to output data including similarity indices, emotion categories, or other predictions.

The term “rule-based model” refers to a logic construct comprising predefined rules or conditions that are applied to input data, including at least one of content features and interaction logs, to derive an output such as an estimated emotional state or a control decision without statistical training.

The term “warning content” refers to information included in warning data that describes a potential copyright infringement risk, including at least one of an indication of high similarity between generated content and existing works, identification of such existing works, and recommended user actions.

The term “presentation detail level” refers to a parameter or setting that determines a degree of granularity or verbosity of information included in a warning or guidance, such that a higher presentation detail level produces a more elaborate explanation and a lower presentation detail level produces a more concise explanation.

The term “user interface presentation format” refers to a configuration of visual or auditory elements used by a user terminal to present warning information or recommended prompt sentences, including at least one of a dialog layout, a multi-section view, a compact view, and arrangement or emphasis of control elements.

The term “warning information” refers to output data generated by the processor that is to be transmitted to a user terminal and that includes at least one of warning content, similarity evaluation results, information related to existing works, guidance for modifying a prompt sentence, a presentation detail level, and a user interface presentation format.

The term “similarity evaluation result” refers to data derived from similarity indices between generated content and existing works, including at least one of the indices themselves, classifications such as high or medium similarity, and identifiers or metadata of candidate existing works.

The term “internal prompt” refers to a prompt formulation that is constructed within the server and is provided to a generative AI model, the internal prompt including at least instructions for rewriting an original prompt sentence so as to reduce similarity to one or more existing works.

The term “recommended prompt sentence” refers to a prompt sentence that is automatically generated by a generative AI model on the basis of an original prompt sentence and similarity evaluation results and that is designed to cause the generative AI model, when used by a user, to generate content with reduced similarity to existing works.

The term “external information processing apparatus” refers to a computing system, distinct from the server and the user terminal, that communicates with the server via a network and issues requests for hash generation, ledger recording, similarity evaluation, emotion estimation, warning generation, or prompt support, and receives corresponding processing results.

The term “communication interface” refers to a hardware and software combination that enables data exchange between the server and an external information processing apparatus or a user terminal, the communication interface including at least one of a network adapter, a communication protocol stack, and an application programming interface endpoint for sending and receiving structured messages.

In one embodiment, a server, a terminal, and a user cooperate to implement the system according to the claims. The server is implemented as a network-connected information processing apparatus that includes at least one central processing unit (CPU), at least one main memory, at least one secondary storage apparatus such as a solid-state drive, at least one graphics processing unit (GPU) or other hardware accelerator, and at least one network interface. The server executes a general-purpose operating system and runs application software including a web server program, an application server framework, and a machine learning framework such as a deep learning framework. The server further uses software libraries including a cryptographic processing library, an image processing library, an audio processing library, a natural language processing library, a vector search library, and a distributed ledger access library.

The terminal is implemented as a user-operated information processing apparatus such as a smart device, a portable information terminal, or a personal computer. The terminal includes a display, input devices such as a touch panel or keyboard, a camera, a microphone, a local storage, and a network interface. The terminal executes a browser application or a dedicated application to communicate with the server and to present content and user interfaces to the user.

The user operates the terminal to input a prompt sentence to be supplied to a generative AI model. The user may input, for example, the following prompt sentences: “Please generate the opening of an adventure story set in a medieval magical kingdom.” “Please draw an impressionist-style landscape painting of a lakeside at sunset.” “Please create a short video set in a futuristic city.”

“Please generate an 8-bar 1980s-style synth-pop melody.”

“Please generate an 8-bar 1980s-style synth-pop melody in MIDI format.”

The terminal captures the prompt sentence as character data, normalizes the character data into a unified encoding such as UTF-8, and attaches metadata including a content type, a user identifier, and a terminal identifier. The terminal sends the prompt sentence and the metadata to the server via an encrypted communication protocol.

The server receives the prompt sentence and selects an appropriate generative AI model according to the content type. In one embodiment, the server uses a language generative AI model for text content, an image generative AI model for image content, a sequence generative AI model for music content, and a video generative AI model for video content. The server implements these models on a deep learning framework such as a tensor computation framework running on the GPU. The server uses a tokenizer or encoder to transform the prompt sentence into token identifiers or continuous vectors and supplies these to the selected generative AI model.

In one embodiment, the language generative AI model is a transformer-based neural network having multiple self-attention layers, feed-forward layers, and layer normalization layers. The server trains this model beforehand by minimizing a language modeling loss such as a cross-entropy loss over large corpora of text, and updates model parameters by a gradient-based optimization method such as an adaptive moment estimation method. During inference, the server uses the trained model to predict a probability distribution over next tokens conditioned on the prompt sentence and previously generated tokens, and samples or decodes tokens according to a decoding strategy such as greedy decoding, beam search, or top-p sampling. The server then decodes the sequence of tokens into a text string as generated content.

In another embodiment, the image generative AI model is a diffusion-type model that iteratively denoises a latent representation conditioned on the encoded prompt sentence. The server runs a denoising step function repeatedly on the GPU, where each step uses a U-Net-like convolutional neural network to predict a noise vector, and the server updates the latent representation by subtracting the predicted noise according to a predefined noise schedule. The server finally decodes the latent representation into an image tensor. In another embodiment, the music generative AI model is an auto-regressive sequence model or a transformer model that outputs symbolic tokens representing pitches, durations, and velocities, or acoustic features such as mel-spectrogram frames. The server trains the model on sequences of musical events using a sequence prediction loss, and the server uses sampling or constrained decoding to generate a melody sequence.

In another embodiment, the video generative AI model generates either a sequence of latent codes for frames or directly a sequence of frames by combining temporal self-attention and spatial convolution operations. The server decodes or refines these latent codes into individual image frames, and then composes them into a video file.

The server converts the generated content from internal tensor representations into standardized external formats. The server uses the image processing library to encode image tensors into image files such as PNG or JPEG. The server uses the audio processing library to encode audio waveforms or MIDI events into audio or MIDI files. The server uses a video processing library or tool to encode sequences of frames and associated audio tracks into a video container format such as MP4. The server stores these files in secondary storage or an external storage service and registers metadata including content identifiers, file paths or uniform resource locators, file sizes, and generation timestamps in a database.

The server then performs type-aware normalization and hashing of the generated content. For text content, the server reads the generated text string from storage, normalizes character encodings and line breaks, and applies deterministic rules to collapse multiple spaces or remove trailing whitespace. The server converts the normalized text into a sequence of bytes using UTF-8 encoding. For image content, the server loads the image file, resizes the image to a predetermined resolution such as 256×256 pixels, converts the color space to a predetermined space such as RGB, and applies a noise reduction filter such as a Gaussian filter. The server then flattens the normalized pixel values into a deterministic sequence of bytes. For video content, the server extracts key frames from the video using a video processing library, for example by selecting frames at regular intervals or using scene change detection, applies the same normalization as for still images to each key frame, and concatenates the byte sequences of all key frames in a predetermined order. For music content, the server loads the audio or MIDI file, computes acoustic features such as mel frequency cepstral coefficients, chroma features, or onset patterns, and serializes these numerical arrays into a deterministic byte sequence.

The server passes each normalized byte sequence to a cryptographic processing library that implements at least one cryptographic hash function such as a 256-bit secure hash function. The server computes a fixed-length hash value for the normalized data and encodes the hash value as a hexadecimal string. Because normalization removes non-semantic differences such as pure formatting differences or encoding noise, the server generates hash values that are stable with respect to content semantics. This stability improves the reliability of existence proof and change detection with respect to the generated content.

The server uses a distributed ledger access library to construct a transaction that includes the hash value and identification information such as a content identifier, a user identifier, and a timestamp. The server encodes the transaction according to a transaction schema defined by the distributed ledger technology, attaches a digital signature using a secret key stored in a secure environment, and transmits the transaction to one or more nodes of the distributed ledger network. The distributed ledger network validates and records the transaction in an append-only block structure using a consensus algorithm. The server receives a transaction identifier or a block identifier that uniquely references the recorded transaction and stores this identifier in association with the content metadata. This structure allows later verification that a particular content and its hash were recorded at or before a particular time, and technically strengthens the integrity and auditability of content records.

The server additionally performs similarity evaluation between the generated content and existing works stored in a storage apparatus. The server maintains, for each existing work, at least one feature vector and associated metadata. For text content, the server uses a natural language processing library to segment the text, convert tokens into vector embeddings with a pre-trained contextual embedding model, and aggregate these into a document embedding vector, for example by using a pooling operation or the representation of a special classification token. For image content, the server uses an image feature extraction model such as a convolutional neural network trained on image data or a local descriptor extraction algorithm, and converts each image into a feature vector or a set of local feature vectors. For audio or music content, the server computes feature sequences such as pitch contours, mel-spectrograms, rhythmic patterns, and statistical aggregates thereof. For video content, the server extracts frame features using an image feature extractor and optionally aggregates them temporally using a temporal pooling operation.

The server stores these features in a vector search library or a database that supports efficient nearest neighbor search. The server indexes feature vectors using a data structure such as an approximate nearest neighbor index to accelerate similarity queries. When a new generated content is normalized and its features are extracted, the server submits a feature query to the vector search library to obtain candidate similar works and their similarity scores. The server calculates similarity indices such as cosine similarity, Euclidean distance, or dynamic time warping distance for time series features. By unifying feature extraction and similarity calculation per content type in this manner, the server improves the consistency and computational efficiency of multi-modal similarity evaluation.

The server also estimates a user's emotional state on the basis of multimodal user information received from the terminal. The terminal, under user consent, uses the camera to capture facial images at a reduced rate suitable for emotion analysis, such as one frame per several seconds, and compresses each frame. The terminal uses the microphone to capture short audio segments during interaction with the content generation or warning screens. The terminal further logs user operations such as button presses, scrolling, and dialog dismissals with time stamps, and captures text input such as comments or free-text feedback from the user. The server receives the multimodal user information and preprocesses each modality. For images, the server resizes and normalizes the facial region and supplies it to a convolutional neural network dedicated to emotion recognition. This convolutional neural network may include multiple convolution layers, pooling layers, and fully connected layers, and outputs a probability distribution over a set of emotion classes. The server trains this network beforehand on labeled facial expression datasets by minimizing a classification loss function and updates weights using a gradient descent-based optimizer. For audio, the server computes features such as pitch, energy, and spectral coefficients using the audio processing library and feeds them to a neural network trained for speech emotion recognition. For text, the server tokenizes user-entered text and passes it to a transformer-based classifier trained to predict sentiment polarity and specific emotion labels.

For operation logs, the server applies either a rule-based model or a machine learning model. In a rule-based embodiment, the server defines non-conventional rules such as: a high frequency of rapid dialog dismissals combined with repeated generation requests without edits indicates increasing frustration; long periods of inactivity after a warning indicates possible discouragement; and frequent cursor movements with no content changes indicates confusion. In a learning-based embodiment, the server encodes operation sequences into feature vectors and applies a classifier to predict engagement or distress levels. The server combines the outputs of these modality-specific models using a fusion algorithm such as a weighted average or Bayesian inference, and obtains final emotion information that includes at least one emotion category and an intensity.

The server uses both the similarity evaluation result and the emotion information to control the generation of warning information in an emotion-adaptive manner. If similarity indices indicate that the generated content is close to one or more existing works beyond a threshold, and if emotion information indicates that the user is discouraged or anxious, the server constructs warning content that includes a plain language explanation of the risk, names of similar existing works, and detailed guidance for modifying the prompt sentence. If emotion information indicates that the user is frustrated or angry, the server generates a concise warning that highlights only the essential risk and offers a simple immediate action such as regenerating content. The server sets a presentation detail level and a user interface presentation format field in the warning information, for example indicating whether a detailed multi-section view or a compact dialog should be used at the terminal. The terminal receives the warning information, selects a user interface layout template according to the presentation format, and renders the warning content on the display. In this manner, the system does not merely display static warning messages but dynamically adapts content and structure of the user interface to the inferred emotional state. This adaptation improves user interaction with the system and leads to more effective utilization of server resources, because users are more likely to follow guidance and avoid repeated ineffective content generation attempts.

The server further implements a prompt support function that uses the generative AI model not only to generate content but also to generate recommended prompt sentences. When the server detects repeated high similarity between generated content and existing works, and when emotion information indicates discouragement or a risk of abandonment, the server constructs an internal prompt for a language generative AI model. This internal prompt includes the original prompt sentence, metadata or summaries of similar existing works, and instructions such as “rewrite the prompt to produce more original content that avoids the themes and specific elements of the listed works.” The server feeds this internal prompt to the generative AI model, which, using its learned parameters, outputs one or more candidate prompt sentences. The server may enforce diversity by controlling sampling parameters or by applying a ranking method that favors prompts that differ more from the original with respect to identified similarity dimensions.

The server selects a recommended prompt sentence from these candidates and sends it to the terminal. The terminal displays the recommended prompt sentence to the user in a text input field together with a control element that allows the user to trigger content generation using the recommended prompt sentence. Because the recommended prompt sentence is constructed using similarity evaluation results and internal processing in the server, the system can guide the user towards content that is likely to be less similar to existing works while preserving the user's creative intent. This approach is different from mere human trial-and-error because the server internally analyzes structured similarity patterns and uses them as control signals for the generative AI model.

The described architecture produces several technical effects. By performing type-aware normalization before hashing, the server reduces the number of distinct hashes that correspond to semantically equivalent content, thereby improving the effectiveness of deduplication and integrity checking. This reduces storage redundancy and search complexity in the distributed ledger and content database. By implementing unified, optimized feature extraction per content type and by using vector search data structures, the server decreases the computational time required for similarity searches compared with naive pairwise comparison, and scales more efficiently with the number of stored works. By integrating emotion estimation into the server's control logic, the server avoids unnecessary or excessively detailed warning generation in cases where it would not be effective, reducing communication load and processing overhead associated with generating and transmitting large warning payloads. By using structured similarity results as inputs to the generative AI model to generate recommended prompt sentences, the server reduces the number of generation cycles required to obtain acceptable content and thereby reduces GPU utilization and overall energy consumption.

In alternative embodiments, the server may use different neural network architectures, such as recurrent neural networks or encoder-decoder models, for some content types. The server may also use different distributed ledger technologies, such as permissioned or public variants, or different hash functions with comparable security properties. The emotional state estimation may rely more heavily on rule-based logic in environments where training data is limited, or may use advanced multi-task learning architectures when training data is abundant. The feature extraction and similarity calculation modules may be configured with different distance metrics or aggregation strategies depending on the domain and performance requirements.

In all embodiments, the server, the terminal, and the user interact in such a way that the processing is not limited to abstract manipulation of data but is tied to specific improvements in computer operation. The server structures and transforms data using particular data formats, normalization rules, hash computations, vector indices, neural network architectures, and control rules; these elements are combined in a non-conventional manner to improve processing speed, accuracy, resource utilization, and robustness of generative AI content management and copyright-risk control.

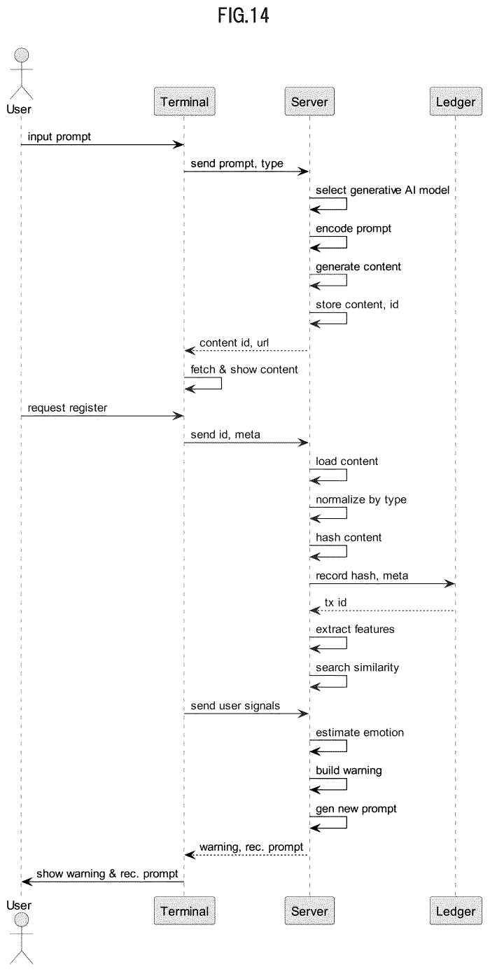

The following describes the processing flow using FIG. 14.

### Step 1:

The user operates the terminal to open a content-generation screen and input a prompt sentence.

Input: The user's keystrokes and touch operations on an input field.

Processing: The terminal captures the input characters from a text widget, normalizes the characters into a unified encoding (for example, UTF-8), and converts platform-dependent line endings into a standard format. The terminal also acquires a content type selection (for example, text, image, music, video) from a UI control and converts it into an internal code.

Output: A normalized prompt sentence string and an internal content type code maintained in the terminal's application state.

### Step 2:

The terminal prepares a request message that includes the prompt sentence and metadata, and sends the message to the server.

Input: The normalized prompt sentence, the content type code, a user identifier, and a terminal identifier.

Processing: The terminal structures these fields into a data object, serializes the data object into a text format such as JSON, and encodes the JSON text into bytes using UTF-8. The terminal establishes a secure communication channel (for example, HTTPS using TLS) to the server and transmits the encoded bytes as the body of an HTTP request.

Output: A network request containing the prompt sentence and metadata delivered to the server.

### Step 3:

The server receives the request and extracts the prompt sentence and metadata.

Input: The HTTP request bytes received over the network interface.

Processing: The server, through a web server and application framework, decodes the bytes as UTF-8 text, parses the JSON structure, and maps JSON keys to internal variables. The server validates required fields and discards malformed input.

Output: Internal representations of the prompt sentence, the content type code, the user identifier, and the terminal identifier stored in server memory.

### Step 4:

The server selects an appropriate generative AI model on the basis of the content type code. Input: The content type code and the prompt sentence.

Processing: The server applies a routing rule that maps each content type code to a pre-configured model identifier (for example, language model, image model, music model, video model). The server loads or references the corresponding model instance from a model registry and obtains its tokenizer or encoder configuration.

Output: A selected generative AI model object and an associated tokenizer or encoder object. Step 5:

The server encodes the prompt sentence into a format suitable for the selected generative AI model.

Input: The prompt sentence string and the tokenizer or encoder object.

Processing: The server splits the prompt sentence into tokens using predefined tokenization rules, maps each token to a numeric identifier, and packs the identifiers into a tensor format expected by the deep learning framework. The server also constructs auxiliary tensors such as attention masks or segment identifiers.

Output: One or more input tensors representing the prompt sentence, ready to be supplied to the generative AI model.

### Step 6:

The server invokes the generative AI model to generate content based on the encoded prompt sentence.

Input: The prompt input tensors and the selected generative AI model instance. Processing: The server sends the input tensors to a GPU device, where the deep learning framework executes the model's forward pass across multiple neural network layers. The server uses an auto-regressive decoding loop or an iterative denoising loop depending on the model: for text, the server repeatedly predicts next-token distributions and samples or selects tokens; for images, the server iteratively updates a latent tensor using a denoising function; for music and video, the server produces sequences of symbolic or frame-level outputs. Output: Raw generated content tensors (for example, token sequences, image tensors, audio feature sequences, or frame tensors) held in server memory.

### Step 7:

The server converts the raw generated content tensors into standardized external content formats.

Input: The raw generated content tensors and the content type code.

Processing: For text, the server maps token identifiers back to characters and concatenates them into a text string. For images, the server scales tensor values to pixel ranges and invokes an image processing library to encode them into image file formats such as PNG or JPEG. For audio or music, the server converts symbolic or feature sequences into MIDI events or PCM waveforms and uses an audio processing library to encode them into MIDI or audio files. For video, the server decodes frame tensors into image frames and uses a video encoding library to combine the frames and optional audio into a video container format.

Output: Generated content files or data streams in external formats (text, image, audio/MIDI, or video).

### Step 8:

The server stores the generated content and registers associated metadata.

Input: The generated content files or streams and the metadata including the user identifier and the content type code.

Processing: The server writes the content files to secondary storage or an object storage service and assigns a unique content identifier. The server records metadata such as the content identifier, storage path or location, file type, file size, and generation timestamp in a database.

Output: A stored content record and a metadata entry, including a content identifier and access location.

Step 9: The server sends content location information to the terminal for preview.

Input: The content identifier and the storage location (for example, a URL or file path). Processing: The server constructs a response object that includes the content identifier, the content type code, and an access reference. The server serializes this object as JSON, encodes it as UTF-8, and sends it as an HTTP response to the terminal.

Output: A response message delivered to the terminal containing references to the generated content.

### Step 10:

The terminal retrieves and presents the generated content to the user.

Input: The response message containing the content identifier and access reference. Processing: The terminal parses the JSON, reads the access reference, and issues a request to obtain the actual content (for example, an HTTP GET request). The terminal decodes the received content using built-in decoders or libraries, creates appropriate UI components (text view, image view, audio player, or video player), and renders or plays the content on the display and speakers.

Output: A preview screen showing or playing the generated content for the user.

### Step 11:

The user decides whether to register the generated content for distribution and issues a registration instruction.

Input: The preview presentation and UI controls such as a “Register” button.

Processing: The user reviews the generated content. If the user chooses to register, the user activates the corresponding UI control.

Output: A registration command generated by user interaction on the terminal.

### Step 12:

The terminal constructs and sends a registration request for the selected content. Input: The registration command, the content identifier, and associated metadata (for example, the original prompt sentence, the content type, and the generation timestamp). Processing: The terminal gathers the metadata from local state or cache, builds a structured registration object, and serializes it as JSON. The terminal transmits the registration object to the server via an HTTP request over an encrypted channel.

Output: A registration request message delivered to the server including the content identifier and relevant metadata.

### Step 13:

The server retrieves the stored content file and prepares it for hashing.

Input: The registration request containing the content identifier and metadata. Processing: The server parses the request, reads the content identifier, and queries the database for the corresponding storage location. The server loads the content file from storage into memory. The server determines the content type from metadata to select a type-specific normalization procedure.

Output: A content file in memory and a selected normalization procedure.

### Step 14:

The server performs type-aware normalization and converts the content into a deterministic byte sequence.

Input: The content file in memory and the content type.

Processing: For text content, the server normalizes line endings, removes extraneous whitespace according to defined rules, and converts the normalized text into a UTF-8 byte array. For image content, the server uses an image processing library to resize the image to a fixed resolution, convert it to a target color space, and apply a noise filter before flattening the pixel data into a byte sequence. For video content, the server extracts key frames and applies the image normalization to each frame, then concatenates all frame bytes in a fixed order. For music content, the server computes acoustic or structural features and serializes the resulting numerical values into a byte array using a predetermined encoding.

Output: A normalized byte sequence representing the content in a canonical form.

### Step 15:

The server computes a cryptographic hash value from the normalized byte sequence. Input: The normalized byte sequence.

Processing: The server invokes a cryptographic hash function implemented in a cryptographic library, supplies the byte sequence as input, and runs the hash computation to completion. The server receives a fixed-length hash digest and converts it into a representation such as a hexadecimal string.

Output: A hash value (digital identification information) of the generated content.

### Step 16:

The server records the hash value and identification data in a distributed ledger. Input: The hash value, the content identifier, the user identifier, and a timestamp. Processing: The server uses a distributed ledger access library to construct a transaction payload that includes the hash value and identification data. The server signs the transaction using a cryptographic key, submits the transaction to ledger nodes, and waits for confirmation that the transaction has been appended to a block. The server receives a transaction identifier or block identifier from the ledger network.

Output: A ledger reference (transaction or block identifier) linked to the content record in the server's database.

### Step 17:

The server extracts similarity features from the generated content for comparison with existing works.

Input: The content file and its type.

Processing: For text content, the server passes the text through a natural language processing model to obtain an embedding vector. For image content, the server applies an image feature extraction model to compute an image feature vector. For music content, the server derives feature sequences and aggregates them into a compact representation. For video content, the server extracts and encodes frame features. The server produces standardized feature structures for each content type.

Output: One or more feature vectors or feature sequences representing the generated content.

### Step 18:

The server performs similarity search and evaluates similarity indices with respect to existing works.

Input: The feature vectors or sequences of the generated content and a feature database of existing works.

Processing: The server submits the generated content features to a vector search engine or database, which uses an index structure to retrieve candidate nearest neighbors. The server calculates similarity indices such as cosine similarity or distance measures between the generated content features and the candidate existing work features, and applies thresholds or ranking rules to determine significant similarities.

Output: A similarity evaluation result including similarity scores and identifiers or metadata of candidate similar existing works.

### Step 19:

The terminal acquires multimodal user information related to the user's interaction during content generation and review.

Input: The user's facial expressions, spoken utterances, text inputs, and UI operations. Processing: The terminal captures facial images via the camera, records short audio segments via the microphone, collects text typed into feedback fields, and logs interaction events such as button clicks and scrolling with timestamps. The terminal compresses or encodes these data and groups them into a multimodal payload.

Output: A multimodal user information payload transmitted from the terminal to the server.

### Step 20:

The server estimates the user's emotional state from the multimodal user information. Input: The multimodal user information payload (facial images, audio, text, and logs). Processing: The server preprocesses each modality (for example, resizing images, extracting audio features, tokenizing text, and summarizing logs) and applies trained models or rule sets to each modality to obtain modality-specific emotion indicators. The server then combines these indicators using a fusion algorithm to compute an overall emotion category and intensity.

Output: Emotion information representing the user's estimated emotional state.

### Step 21:

The server generates warning information based on the similarity evaluation result and the emotion information.

Input: The similarity evaluation result and the emotion information.

Processing: The server determines whether the similarity scores exceed predefined thresholds and classifies the level of copyright risk. If risk is present, the server constructs warning content describing the risk and referencing similar works. The server then uses the emotion information to select a presentation detail level and a user interface format (for example, detailed view for discouraged users, compact view for frustrated users). The server packages the warning content, guidance text, similar work metadata, and presentation parameters into a warning information object.

Output: A warning information object ready to be transmitted to the terminal.

### Step 22:

The server creates a recommended prompt sentence using a generative AI model when similarity is high.

Input: The original prompt sentence, the similarity evaluation result, and a language generative AI model.

Processing: The server builds an internal prompt that includes instructions to reduce similarity and descriptions or summaries of similar works. The server encodes this internal prompt into tokens and feeds it to the language generative AI model, which outputs one or more candidate revised prompt sentences. The server optionally ranks or filters the candidates and selects at least one recommended prompt sentence.

Output: One or more recommended prompt sentences associated with the original content.

### Step 23:

The server transmits the warning information and the recommended prompt sentence to the terminal.

Input: The warning information object and the recommended prompt sentences.

Processing: The server serializes these objects as JSON, encodes them as UTF-8 bytes, and sends them in an HTTP response or a push message to the terminal.

Output: A response message containing warning information and recommended prompt sentences delivered to the terminal.

### Step 24:

The terminal presents the warning information and the recommended prompt sentence to the user and enables corrective actions.

Input: The response message containing the warning information and recommended prompt sentences.

Processing: The terminal parses the JSON, selects a layout based on the presentation format field, and renders the warning message, similar work list, and guidance text in the user interface. The terminal populates an editable text field with a recommended prompt sentence and displays controls that allow the user to accept, modify, or reject the recommended prompt sentence, and to trigger new content generation.

Output: An updated user interface that conveys the warning and presents options for revising the prompt sentence and regenerating content.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

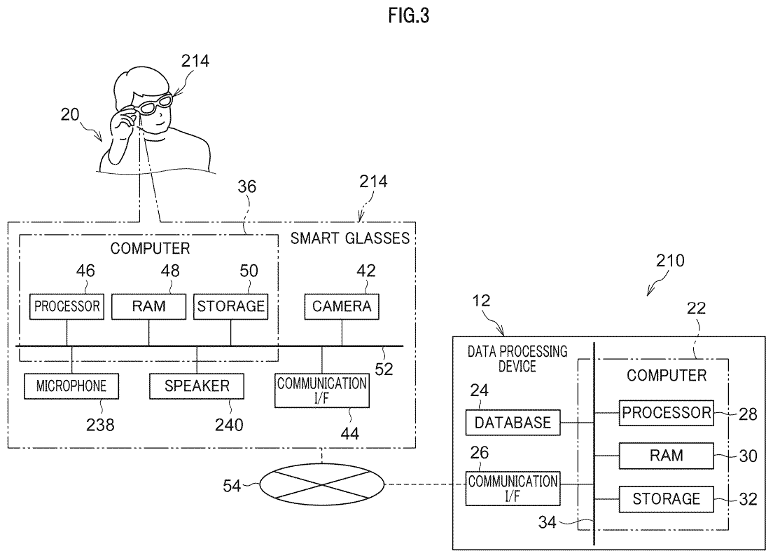

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

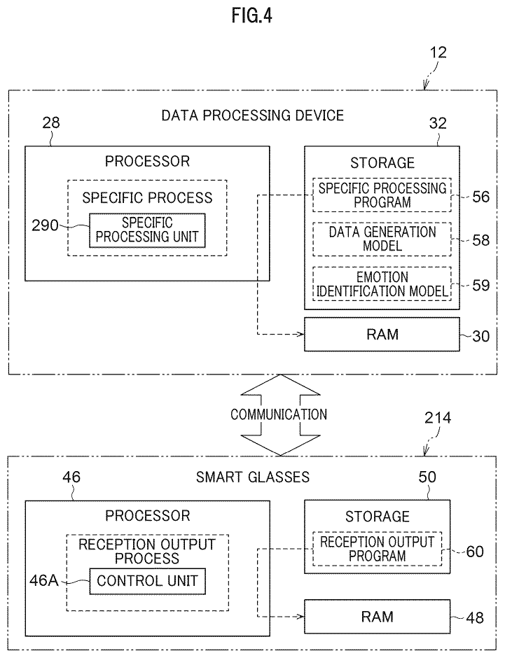

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

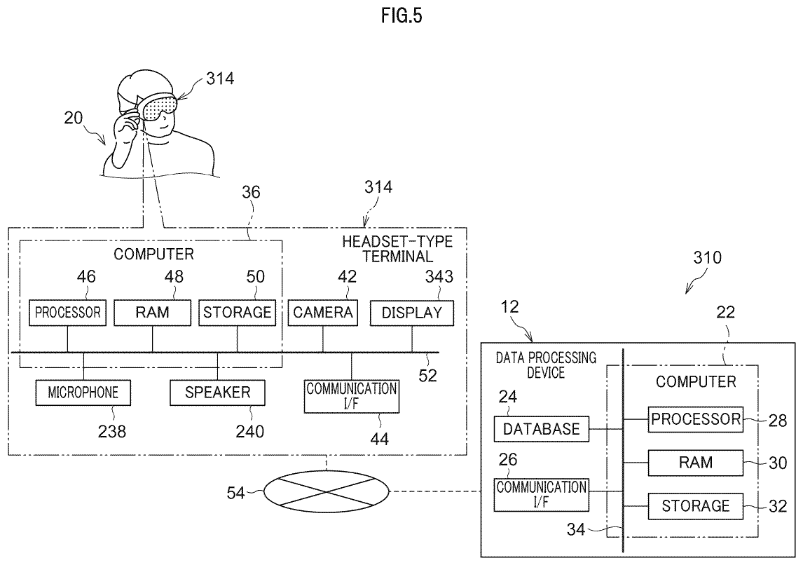

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

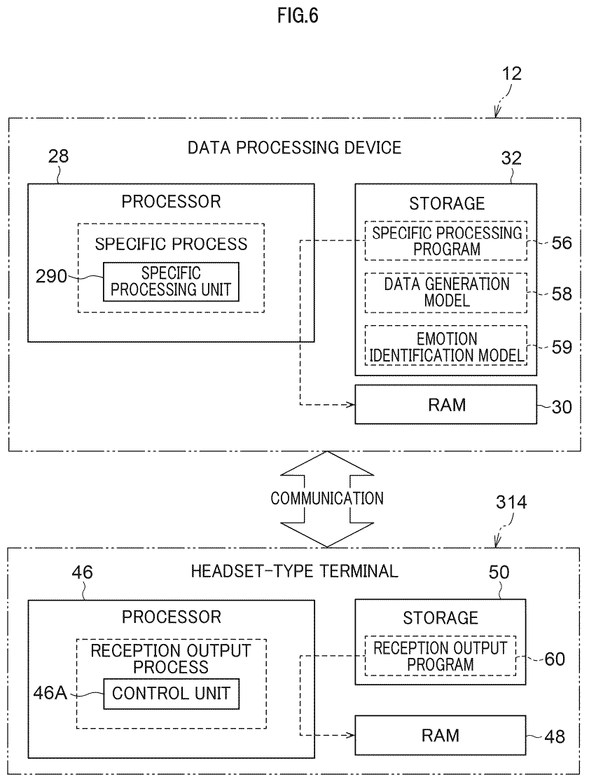

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

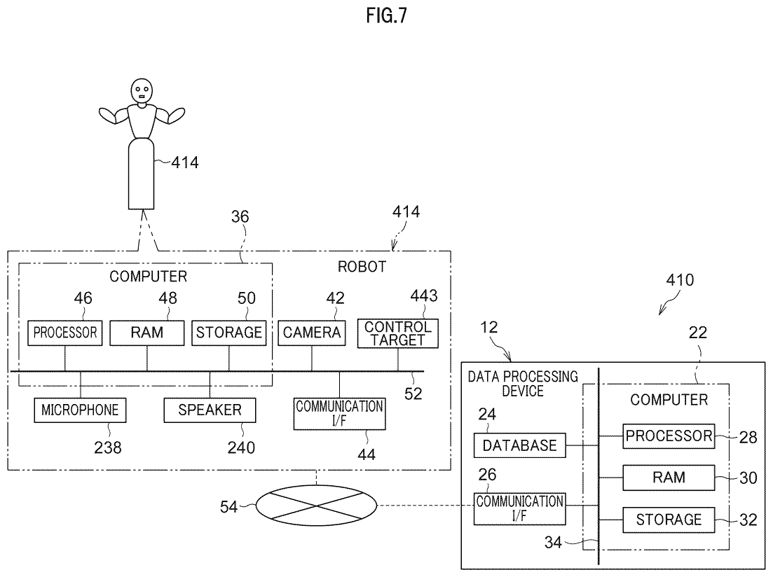

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

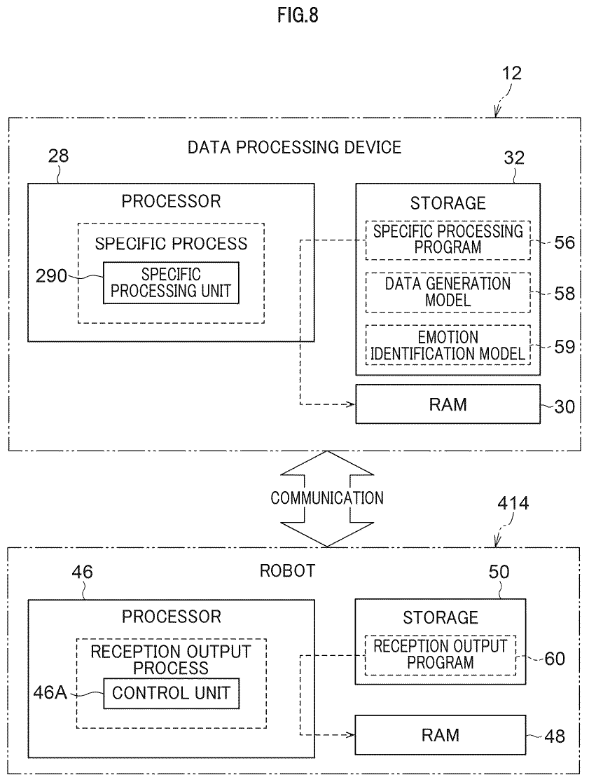

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

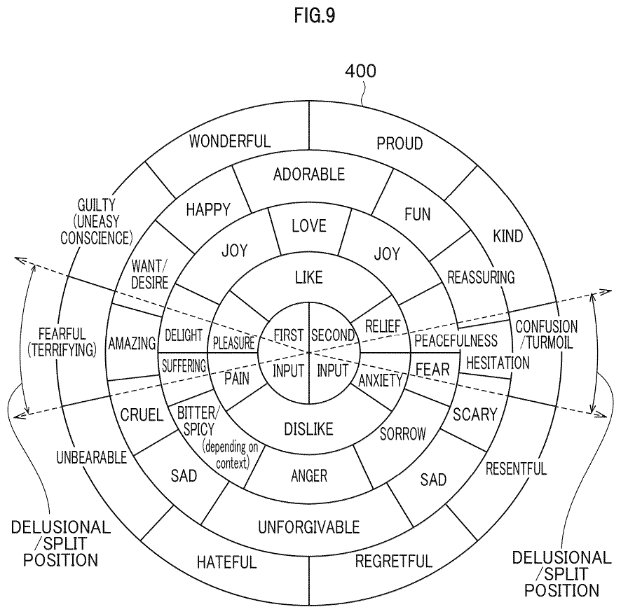

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

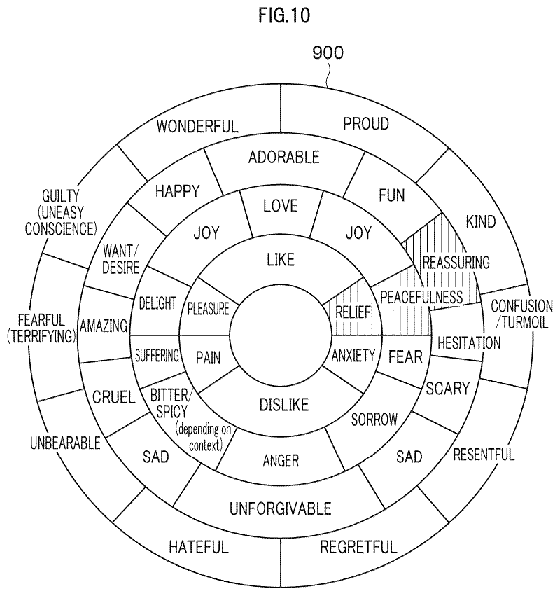

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a user terminal, generated information created by a generative information processing apparatus, as input information, and store the input information together with attribute information of the input information, convert the input information into identification information by reading an entirety of the input information as an information sequence and applying a cryptographic summary operation to the information sequence so as to generate fixed-length identification information uniquely representing a digital fingerprint of the input information,
store the identification information in association with the attribute information and time information in a storage medium, and transmit, to a distributed recording infrastructure, transaction information including at least the identification information and the time information so that the identification information is recorded in a tamper-resistant manner, and acquire, as preservation information, recording result information returned from the distributed recording infrastructure,
determine an information type of the input information, obtain the input information as at least one of character information, image information, and video information based on the determined information type, convert the input information into feature information, compare the feature information with feature information of reference information that has been previously registered, and calculate a similarity index for evaluating similarity between the input information and the reference information,
determine, based on the similarity index and a predetermined decision condition, a classification of rights-infringement risk for the input information, and, when the classification is greater than or equal to a threshold, generate warning information including identification information of the reference information and the similarity index and transmit the warning information to the user terminal,
execute, in response to a call from an external generative information processing platform, at least a part of a sequence of processing including receiving the input information, converting the input information into the identification information, recording the identification information in the distributed recording infrastructure, and calculating the similarity index, and return a result of the sequence of processing to the external generative information processing platform in a machine-readable format via a communication interface, and provide, based on the similarity index and the preservation information, at least one of usage permission information and re-generation recommendation information for the generated information to the generative information processing apparatus so as to enable integrated control of generation processing performed by the generative information processing apparatus and rights-management processing performed by the system.

### (Supplementary 2)

The system according to supplementary 1,
wherein the processor is configured to, when the input information is character information, divide the character information into unit elements using a natural language processing technique, convert the unit elements into numerical representations to generate feature vectors, and calculate the similarity index based on an angle in a vector space between the feature vectors and feature vectors corresponding to the reference information,
wherein the processor is configured to, when the input information is image information, extract at least one of local features and deep features from the image information using an image recognition technique, and calculate the similarity index based on a distance between the extracted features and features corresponding to the reference information, and
wherein the processor is configured to, when the input information is video information, divide the video information along a time direction into a plurality of still image pieces, process each still image piece as the image information to obtain features, aggregate the features in the time direction to generate video features, and calculate the similarity index between the video features and video features corresponding to the reference information.

### (Supplementary 3)

The system according to supplementary 1,
wherein the processor is configured to receive, from the external generative information processing platform, a processing request including instruction information used when the generated information is created and including the generated information, automatically execute, in response to the processing request, a sequence of processing including at least generation of the identification information, recording of the identification information in the distributed recording infrastructure, and calculation of the similarity index, and return, to the external generative information processing platform, evaluation information including the preservation information and the classification of the rights-infringement risk as a result of the sequence of processing.

### Application Example 1

### (Supplementary 1)

A system comprising a processor,
wherein the processor is configured to acquire generated content data and corresponding prompt sentence data received from a terminal,
and associate the acquired generated content data and the prompt sentence data with identification information and store the associated data in a storage, and, based on the identification information, read out the generated content data from the storage, and execute normalization processing on content of the generated content data in accordance with a type of the generated content data and sequentially calculate a hash value by applying a hash function to the normalized content so as to generate a hash value representing a digital fingerprint of the generated content data,
and generate transaction data including the hash value and transmit the transaction data to a distributed ledger node so that the hash value is recorded in a block of a distributed ledger in a tamper-resistant manner,
and generate a set of feature vectors of the generated content data by, in accordance with the type of the generated content data, performing vectorization processing using a natural language processing algorithm for text data, performing feature extraction using an image feature extraction algorithm for image data, and extracting time-frequency features or frame features for audio data or video data,
and compare the generated set of feature vectors with a set of feature vectors of existing copyrighted works registered in advance in an existing work database by using a vector similarity calculation algorithm, calculate a similarity index between the generated content data and each existing copyrighted work, and extract, as similarity candidates, existing copyrighted works for which the similarity index exceeds a threshold,
and generate warning information data for a user based on copyright information corresponding to the extracted similarity candidates, the similarity index, and matching section information corresponding to the similarity candidates, and transmit the warning information data to the terminal so that the warning information data is displayed on the terminal,
and provide an application programming interface that, in response to a processing request from an external content distribution platform or an external generative artificial intelligence platform, allows at least one of content upload, hash value generation, distributed ledger recording, and similarity checking to be invoked.

### (Supplementary 2)

The system according to supplementary 1,
wherein the processor is configured to, in the comparison between the set of feature vectors of the generated content data and the set of feature vectors of the existing copyrighted works, for text data, calculate a cosine similarity or a set similarity between vector representations obtained by converting token sequences of the text into weighted vectors,
and, for image data or frame data of video, calculate a distance between feature vectors generated by local feature extraction or by a deep learning model,
and, for audio data or an audio section of video, calculate a similarity between time-frequency feature sequences by using a time axis alignment algorithm,
and extract the matching section information between the generated content data and the existing copyrighted works based on the calculated similarity index.

### (Supplementary 3)

The system according to supplementary 1,
wherein the processor is configured to include, in the warning information data, the prompt sentence data used for generation of the generated content data and guidance information for modifying the prompt sentence data so as to reduce the similarity index, and to cause, through the terminal, presentation of information that prompts a user to iteratively modify the generated content data by changing the prompt sentence data and inputting the modified prompt sentence data again to a generative artificial intelligence model.

### Example 2

### (Supplementary 1)

A system comprising a processor,

wherein the processor is configured to
receive, from an information processing apparatus or an information processing service, a prompt sentence and generated information that has been generated by a generative AI model based on the prompt sentence,
generate, by using a hash function, identification information having a fixed length that uniquely identifies content of the generated information,
transmit the identification information, as a transaction, to a distributed ledger and cause the distributed ledger to record the identification information in a tamper-resistant manner, calculate, based on the generated information and pre-stored existing information resources, a numerical similarity degree between the generated information and each of the existing information resources, and evaluate whether the generated information is similar to the existing information resources,
estimate an emotional state of a user by receiving at least part of imaging data, audio data, and operation log data acquired from an imaging device, an audio acquisition device, and an operation input device, respectively, and by executing feature extraction processing and inference processing on the imaging data, the audio data, and the operation log data to obtain an emotion category and an emotion intensity representing the emotional state of the user, determine content and an expression style of warning information relating to a risk of copyright infringement, based on the similarity degree calculated by the similarity evaluation and the emotional state estimated by the emotion estimation, and output the warning information to the information processing apparatus,
provide, via a communication interface, at least part of processing functions of hash generation, distributed ledger recording, and similarity evaluation to an external generative information processing service, the external generative information processing service being configured to generate the generated information by the generative AI model based on the prompt sentence and to transmit the generated information and the prompt sentence to the system, and
control display of an operation screen on a terminal apparatus, the operation screen enabling a user to input the prompt sentence, to view a generation result produced by the generative AI model, to execute a start operation for copyright management processing, and to select a response policy based on the warning information, and transmit the generated information, the prompt sentence, and identification information of the generative AI model from the terminal apparatus to the system.

### (Supplementary 2)

The system according to supplementary 1,
wherein the processor is configured to
execute, for the imaging data, image processing by an image processing program to perform extraction and normalization of a face region, execute, for the audio data, audio processing by an audio processing program to extract acoustic features, execute, for the operation log data, calculation of statistical information and time-series change patterns to obtain feature vectors, input the feature vectors to a trained model for machine learning to estimate scores for a plurality of emotion categories, integrate the scores for the plurality of emotion categories to generate a single emotion state label and an emotion intensity vector, and store the emotion state label and the emotion intensity vector in association with the identification information recorded in the distributed ledger.

### (Supplementary 3)

The system according to supplementary 1,
wherein the processor is configured to
execute, for generated information in a text format, natural language processing by a natural language processing program to perform tokenization processing and calculation of a feature vector, execute, for generated information in an image format or a video format, image processing by an image processing program to perform feature extraction processing, calculate in advance feature vectors of the existing information resources of corresponding types, calculate a similarity score based on a distance or an angle between the feature vector of the generated information and the feature vector of each of the existing information resources, extract as similarity candidates those existing information resources whose similarity scores are equal to or greater than a predetermined threshold value, and provide identification information and similarity scores of the similarity candidates to warning processing that generates the warning information.

### Application Example 2

### (Supplementary 1)

A system comprising a processor,
wherein the processor is configured to
receive, from a user terminal, a prompt sentence and generated content created by a generative AI model on a basis of the prompt sentence, as input data,
perform, for the generated content received from the user terminal, normalization processing or feature extraction processing according to a content type of the generated content, and apply a hash function to a data sequence obtained by the processing to generate a hash value as digital identification information of the generated content,
record, in a distributed ledger, the hash value and identification information related to the generated content as transaction information in an appendable and tamper-resistant format to store existence-proof information for the generated content,
extract, from the generated content or from a preprocessing result of the generated content, a feature according to the content type, and calculate a similarity index between the feature of the generated content and a feature previously stored for an existing work, thereby evaluating similarity between the generated content and the existing work,
acquire, from the user terminal, at least part of facial image data, audio data, text input data, or operation log data as multimodal user information, and estimate an emotional state of a user by using a machine learning model or a rule-based model on a basis of the multimodal user information to generate emotion information indicating an emotion category or an emotion intensity of the user,
determine, on a basis of the similarity index and the emotion information, warning content, a presentation detail level, and a user interface presentation format relating to a copyright infringement risk, and generate warning information to be transmitted to the user terminal in accordance with the determined warning content, presentation detail level, and user interface presentation format,
generate, on a basis of a similarity evaluation result included in the warning information and an original prompt sentence, an internal prompt for the generative AI model, and cause the generative AI model to automatically generate a recommended prompt sentence that rewrites the original prompt sentence so as to reduce similarity to the existing work, and provide the recommended prompt sentence to the user terminal, and
provide a communication interface that, in response to a request from an external information processing apparatus, calls at least part of functions for hash generation, ledger recording, similarity evaluation, emotion estimation, warning generation, or prompt support, and transmits and receives processing results between the system and the external information processing apparatus.

### (Supplementary 2)

The system according to supplementary 1,
wherein the processor is configured to
convert, for text content, a text string obtained by normalizing a character code and whitespace of the text content into a byte sequence, convert, for image content, pixel data normalized to a predetermined size and a predetermined color space of the image content into a byte sequence, extract, for video content, key frames from video data and normalize each key frame as image content to generate a concatenated byte sequence, and generate, for music content, a byte sequence by extracting an acoustic feature sequence from audio data or music data and serializing the acoustic feature sequence, apply a cryptographic hash function to each of the byte sequences to calculate a one-way fixed-length hash value, and record, as transaction data, the hash value and identification information related to the generated content in the distributed ledger implemented by distributed ledger technology, and store transaction identification information or block identification information corresponding to the transaction data in association with metadata of the generated content so as to prove existence and attribution of the generated content at a generation time.

### (Supplementary 3)

The system according to supplementary 1,
wherein the processor is configured to
generate, for text content, a document embedding vector by a natural language processing model and calculate a vector-based similarity between the document embedding vector and an embedding vector of each existing work, generate, for image content, an image feature vector by an image feature extraction model and execute vector search with respect to feature vectors of existing images, compare, for video content, image features of a plurality of frames extracted from video data with frame features of existing videos, calculate, for music content, a pattern similarity with existing music on a basis of an acoustic feature or a music-structure feature using time alignment processing, generate, on a basis of similarity indices obtained by the calculations, a similarity evaluation result of the generated content and candidate work information related to similar existing works, and control a presentation format of the warning information and the recommended prompt sentence in accordance with the similarity evaluation result and the emotion information.

What is claimed is:

1. A system comprising:
circuitry configured to:
receive, via a communication interface coupled to a packet-switched network, input data generated by a generative information processing apparatus, and store the input data together with attribute data in a memory;
convert the input data into identification data by reading the input data as an information sequence and applying a cryptographic hash function to the information sequence to generate fixed-length identification data representing a digital fingerprint of the input data;
transmit, to a distributed recording infrastructure via the packet-switched network, transaction data comprising the identification data and temporal data, and receive recording result data from the distributed recording infrastructure;
determine a data type of the input data, convert the input data into feature data based on the determined data type, compare the feature data with feature data of previously registered reference data, and calculate a similarity index between the input data and the reference data;
determine, based on the similarity index and a predetermined decision condition, a risk classification for the input data, and, when the risk classification satisfies a threshold condition, generate alert data comprising identification data of the reference data and the similarity index and transmit the alert data to a client terminal via the packet-switched network; and
provide, based on the similarity index and the recording result data, at least one of usage permission data or re-generation recommendation data to the generative information processing apparatus.

2. The system according to claim 1, wherein the circuitry is configured to determine the data type of the input data as at least one of character data, image data, audio data, or video data, and to apply a normalization routine corresponding to the determined data type to generate normalized data prior to converting the input data into the feature data.

3. The system according to claim 2, wherein the normalization routine comprises, for character data, converting to a standard encoding and normalizing whitespace, for image data, converting to a standard color space and resizing to a canonical resolution, for audio data, resampling to a standard sampling rate and normalizing amplitude levels, and for video data, extracting key frames at fixed time intervals and converting the key frames to a standard color space.

4. The system according to claim 3, wherein the circuitry is configured to convert the input data into the feature data by, for character data, tokenizing the character data, mapping tokens to embeddings, processing the embeddings through a transformer-based encoder, and computing a fixed-dimensional document embedding by aggregating hidden states.

5. The system according to claim 4, wherein the circuitry is configured to convert the input data into the feature data by, for image data, passing a normalized image tensor into an image encoder comprising a convolutional neural network or a vision transformer, computing intermediate feature maps, and applying pooling and projection operations to derive feature vectors.

6. The system according to claim 5, wherein the circuitry is configured to convert the input data into the feature data by, for video data, passing normalized key frames through an image encoder to produce frame-level feature vectors and aggregating the frame-level feature vectors over time using pooling or sequence encoding.

7. The system according to claim 1, wherein the circuitry is configured to compare the feature data with the feature data of the previously registered reference data by querying an approximate nearest neighbor index with the feature data to retrieve candidate reference data, and computing the similarity index using at least one of cosine similarity or Euclidean distance.

8. The system according to claim 7, wherein the circuitry is configured to compute matching section data by identifying positions or intervals in the feature data and in corresponding feature data of the reference data that contribute to the similarity index exceeding the threshold condition.

9. The system according to claim 8, wherein the circuitry is configured to generate prompt modification guidance data based on the similarity index and matching section data, the prompt modification guidance data comprising suggested changes to an original prompt associated with the input data to reduce the similarity index upon re-generation.

10. The system according to claim 1, wherein the circuitry is configured to sign the transaction data with a private key using a cryptographic signing algorithm prior to transmitting the transaction data to the distributed recording infrastructure, and wherein the recording result data comprises a transaction identifier, a block identifier, and a ledger timestamp.

11. The system according to claim 1, wherein the circuitry is configured to receive, via the communication interface, a prompt sentence associated with the input data from the client terminal, and to store the prompt sentence in association with the input data and the identification data in the memory.

12. The system according to claim 1, wherein the circuitry is configured to execute, in response to a call from an external generative information processing platform received via the communication interface, at least a part of a sequence of processing comprising receiving the input data, generating the identification data, recording the identification data in the distributed recording infrastructure, and calculating the similarity index, and to return a result of the sequence of processing to the external generative information processing platform in a machine-readable format.

13. The system according to claim 1, wherein the circuitry is configured to receive, from the client terminal, a modified prompt sentence generated based on the re-generation recommendation data, transmit the modified prompt sentence to the generative information processing apparatus, receive re-generated input data, and repeat the converting, transmitting, determining, and comparing for the re-generated input data.

14. The system according to claim 10, wherein the circuitry is configured to receive, from the client terminal, a verification request comprising identification data of previously registered input data, query the distributed recording infrastructure via the packet-switched network using the identification data, receive ledger record data, and compare the ledger record data with locally stored identification data to generate a verification result indicating whether the previously registered input data has been tampered with.

15. The system according to claim 1, wherein the circuitry is configured to receive a plurality of input data items from the generative information processing apparatus in a batch, compute identification data and feature data for each input data item, aggregate the transaction data for the plurality of input data items into a single batch transaction, and transmit the batch transaction to the distributed recording infrastructure.

16. The system according to claim 1, wherein the circuitry is configured to receive, from the client terminal, emotion state data estimated from at least one of audio data, image data, or behavioral interaction data, and to adjust a presentation format of the alert data transmitted to the client terminal based on the emotion state data.

17. The system according to claim 1, wherein the circuitry is configured to apply the cryptographic hash function by initializing a hash computation context, reading the information sequence in fixed-size blocks, feeding each block into the hash function to update a hash state, and finalizing the hash computation to obtain the fixed-length identification data.

18. A system comprising:
circuitry configured to:
receive, via a communication interface coupled to a packet-switched network, input data generated by a generative information processing apparatus, and store the input data with attribute data in a memory;
apply a cryptographic hash function to the input data to generate fixed-length identification data representing a digital fingerprint of the input data;
transmit transaction data comprising the identification data and temporal data to a distributed recording infrastructure via the packet-switched network, and receive recording result data;
convert the input data into feature data using a feature extraction model, compare the feature data with feature data of previously registered reference data, and calculate a similarity index;
determine a risk classification based on the similarity index and a predetermined decision condition, and generate alert data when the risk classification satisfies a threshold condition; and
provide, based on the similarity index and the recording result data, at least one of usage permission data or re-generation recommendation data to the generative information processing apparatus.

19. The system according to claim 18, wherein the circuitry is further configured to execute, in response to a call from an external generative information processing platform received via the communication interface, at least a part of a sequence of processing comprising receiving the input data, generating the identification data, recording the identification data, and calculating the similarity index, and to return a result in a machine-readable format.

20. A method performed by circuitry of a system, the method comprising:
receiving, via a communication interface coupled to a packet-switched network, input data generated by a generative information processing apparatus, and storing the input data with attribute data in a memory;
converting the input data into identification data by applying a cryptographic hash function to generate fixed-length identification data representing a digital fingerprint of the input data;
transmitting transaction data comprising the identification data and temporal data to a distributed recording infrastructure via the packet-switched network, and receiving recording result data;
determining a data type of the input data, converting the input data into feature data based on the determined data type, comparing the feature data with feature data of previously registered reference data, and calculating a similarity index;
determining a risk classification based on the similarity index and a predetermined decision condition, and generating alert data when the risk classification satisfies a threshold condition; and
providing, based on the similarity index and the recording result data, at least one of usage permission data or re-generation recommendation data to the generative information processing apparatus.
